(19) United States
(12) Patent Application Publication
(10) Pub. No.: US 2025/0355150 A1
(43) Pub. Date: Nov. 20, 2025

(54) Solar Control Coating With Moderate Reflectance and Improved Aesthetics

(71) Applicant: Vitro Flat Glass LLC, Cheswick, PA (US)

(72) Inventors: Jianhua Li, Pittsburgh, PA (US); Patrick Fisher, Pittsburgh, PA (US); Paul A. Medwick, Wexford, PA (US); Andrew Wagner, Pittsburgh, PA (US)

(21) Appl. No.: 19/208,760

(22) Filed: May 15, 2025

Related U.S. Application Data
(60) Provisional application No. 63/648,841, filed on May 17, 2024.

(51) Int. Cl. G02B 5/20; C03C 17/36

(52) U.S. Cl. CPC G02B 5/208; C03C 17/3644; C03C 17/3649; C03C 17/366; C03C 17/3681; C03C 2217/211; C03C 2217/216; C03C 2217/256; C03C 2217/258; C03C 2217/27; C03C 2218/15

(57) ABSTRACT

A coated article includes a substrate and a functional coating over the substrate. The functional coating includes a first dielectric layer, a continuous first metallic layer, a first primer layer, a second dielectric layer including a first film and a second film, a discontinuous second metallic layer, a second primer layer, a third dielectric layer including a first film and a second film, a continuous third metallic layer, a third primer layer, a fourth dielectric layer, and a protective layer. The coated article includes an exterior reflectance b* (Rg b*) of 12>Rgb*>6; an interior reflectance of less than or equal to 16%; and a visible light transmittance of at least 40%. A coated transparency and a method of making a coated article are also provided.

### CROSS-REFERENCE TO RELATED APPLICATIONS

This application claims priority to U.S. Provisional Application No. 63/648,841, filed May 17, 2024, the disclosure of which is incorporated by reference in its entirety.

### BACKGROUND OF THE INVENTION

### Field of the Invention

This invention relates generally to coated articles and coated transparencies having a functional coating and methods of making the same, wherein the coated articles and coated transparencies have an exterior reflectance b* (Rg b*) of 12>Rgb*>6, an interior reflectance of less than or equal to 16%, and a visible light transmittance of at least 40%.

### Background of the Invention

Solar control coatings block or filter selected ranges of electromagnetic radiation, typically radiation in the infrared region and/or ultraviolet region of the electromagnetic spectrum. These solar control coatings are placed on transparencies, such as windows, to reduce the amount of selected ranges of solar energy entering a building. This reduces the heat buildup inside the building.

However, the accessible regions of the aesthetic/color space that are most broadly appealing and that can be reached using conventional solar control coatings employing one or more repeats of dielectric/silver/dielectric structures, are constrained by the designs of conventional solar control coatings.

Thus, it would be desirable to provide a solar control coating for a transparency that provides an appealing champagne-like or soft-gray aesthetic/color, while also maintaining a high visible light transmittance, a low interior visible light reflectance, and a moderate exterior reflectance.

### SUMMARY OF THE INVENTION

The invention relates to a coated article comprising a substrate comprising a first surface and a second surface opposite the first surface and a functional coating over at least a portion of the second surface of the substrate. The functional coating comprises: a first dielectric layer over at least a portion of the second surface of the substrate; a first metallic layer over at least a portion of the first dielectric layer, wherein the first metallic layer is a continuous metallic layer; a first primer layer over at least a portion of the first metallic layer; a second dielectric layer over at least a portion of the first primer layer, wherein the second dielectric layer comprises a first film over at least a portion of the first primer layer and a second film over at least a portion of the first film; a second metallic layer over at least a portion of the second film of the second dielectric layer, wherein the second metallic layer is a discontinuous metallic layer; a second primer layer over at least a portion of the second metallic layer; a third dielectric layer over at least a portion of the second primer layer; a third metallic layer over at least a portion of the third dielectric layer, wherein the third metallic layer is a continuous metallic layer; a third primer layer over at least a portion of the third metallic layer; a fourth dielectric layer over at least a portion of the third primer layer; and a protective layer over at least a portion of the fourth dielectric layer. The coated article comprises: an exterior reflectance b* (Rg b*) of 12>Rg b*>6; an interior reflectance of less than or equal to 16%; and a visible light transmittance of at least 40%.

The invention also relates to a coated transparency comprising first substrate comprising a No. 1 surface and a No. 2 surface opposite the No. 1 surface a second substrate comprising a No. 3 surface and No. 4 surface opposite the No. 3 surface, wherein the second substrate is spaced apart from the first substrate, wherein the No. 3 surface faces the No. 2 surface, and wherein the first substrate and the second substrate are connected together; and a functional coating over at least a portion of the No. 2 surface of the first substrate or the No. 3 surface of the second substrate. The functional coating comprises: a first dielectric layer over at least a portion of the second surface of the substrate; a first metallic layer over at least a portion of the first dielectric layer, wherein the first metallic layer is a continuous metallic layer; a first primer layer over at least a portion of the first metallic layer; a second dielectric layer over at least a portion of the first primer layer, wherein the second dielectric layer comprises a first film over at least a portion of the first primer layer and a second film over at least a portion of the first film; a second metallic layer over at least a portion of the second film of the second dielectric layer, wherein the second metallic layer is a discontinuous metallic layer; a second primer layer over at least a portion of the second metallic layer; a third dielectric layer over at least a portion of the second primer layer; a third metallic layer over at least a portion of the third dielectric layer, wherein the third metallic layer is a continuous metallic layer; a third primer layer over at least a portion of the third metallic layer; a fourth dielectric layer over at least a portion of the third primer layer; and a protective layer over at least a portion of the fourth dielectric layer. The coated transparency comprises: an exterior reflectance b* (Rg b*) of 12>Rg b*>6; an interior reflectance of less than or equal to 16%; and a visible light transmittance of at least 40%.

The invention also relates to a method of making a coated article, the method comprising providing a substrate comprising a first surface and a second surface opposite the first surface and forming a functional coating over at least a portion of the second surface of the substrate. Forming the functional coating comprises: forming a first dielectric layer over at least a portion of the second surface of the substrate; forming a first metallic layer over at least a portion of the first dielectric layer, wherein the first metallic layer is a continuous metallic layer; forming a first primer layer over at least a portion of the first metallic layer; forming a second dielectric layer over at least a portion of the first primer layer, wherein forming the second dielectric layer comprises forming a first film over at least a portion of the first primer layer and forming a second film over at least a portion of the first film; forming a second metallic layer over at least a portion of the second film of the second dielectric layer, wherein the second metallic layer is a discontinuous metallic layer; forming a second primer layer over at least a portion of the second metallic layer; forming a third dielectric layer over at least a portion of the second primer layer; forming a third metallic layer over at least a portion of the third dielectric layer, wherein the third metallic layer is a continuous metallic layer; forming a third primer layer over at least a portion of the third metallic layer forming a fourth dielectric layer over at least a portion of the third primer layer; and forming a protective layer over at least a portion of the fourth dielectric layer. The coated article comprises: an exterior reflectance b* (Rg b*) of 12>Rg b*>6; an interior reflectance of less than or equal to 16%; and a visible light transmittance of at least 40%.

### BRIEF DESCRIPTION OF THE DRAWINGS

The invention will be described with reference to the following drawing figures wherein like reference numbers identify the parts throughout.

FIG. 1 is a sectional view (not to scale) of a coated article according to an example of the invention.

FIGS. 2A and 2B are sectional views (not to scale) of coated articles according to examples of the invention.

FIGS. 3A and 3B are side views (not to scale) of exemplary insulating glass units (“IGU”) according to examples of the invention.

### DESCRIPTION OF THE INVENTION

As used herein, spatial or directional terms, such as “left”, “right”, “inner”, “outer”, “above”, “below”, and the like, relate to the invention as it is shown in the drawing figures. However, it is to be understood that the invention can assume various alternative orientations and, accordingly, such terms are not to be considered as limiting. Further, as used herein, all numbers expressing dimensions, physical characteristics, processing parameters, quantities of ingredients, reaction conditions, and the like, used in the specification and claims are to be understood as being modified in all instances by the term “about”. Accordingly, unless indicated to the contrary, the numerical values set forth in the following specification and claims may vary depending upon the desired properties sought to be obtained by the present invention. At the very least, and not as an attempt to limit the application of the doctrine of equivalents to the scope of the claims, each numerical value should at least be construed in light of the number of reported significant digits and by applying ordinary rounding techniques. Moreover, all ranges disclosed herein are to be understood to encompass the beginning and ending range values and any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more and ending with a maximum value of 10 or less, e.g., 1 to 3.3, 4.7 to 7.5, 5.5 to 10, and the like. Further, as used herein, the terms “formed over”, “deposited over”, or “provided over” mean formed, deposited, or provided on but not necessarily in contact with the surface. For example, a coating layer “formed over” a substrate does not preclude the presence of one or more other coating layers or films of the same or different composition located between the formed coating layer and the substrate. The terms “visible region”, “visible light”, or “visible light spectrum” refer to electromagnetic radiation having a wavelength in the range of 380 nm to 800 nm. The terms “infrared region”, “infrared radiation”, or “infrared spectrum” refer to electromagnetic radiation having a wavelength in the range of greater than 800 nm to 100,000 nm. The terms “ultraviolet region”, “ultraviolet radiation”, or “ultraviolet (UV) spectrum” mean electromagnetic energy having a wavelength in the range of 300 nm to less than 380 nm. Additionally, all documents, such as, but not limited to, issued patents and patent applications, referred to herein are to be considered to be “incorporated by reference” in their entirety. As used herein, the term “film” refers to a coating region of a desired or selected coating composition. A “layer” can comprise one or more “films”, and a “coating” or “coating stack” can comprise one or more “layers”. The term “critical thickness” means a thickness above which a coating material forms a continuous, uninterrupted layer and below which is below the coating material's percolation threshold.

Weight percentages (wt. %) of the metal oxides, metal alloys, metal nitrides, or metal oxynitrides, as used herein, are based on the total weight of the metal components and exclude the weight of any oxide, nitride, or oxynitride components.

The invention is directed to a coated article. The coated article comprises a substrate comprising a first surface and a second surface opposite the first surface. The coated article further comprises a functional coating over at least a portion of the second surface of the substrate. The functional coating comprises a first dielectric layer over at least a portion of the second surface of the substrate. The functional coating further comprises a first metallic layer over at least a portion of the first dielectric layer, wherein the first metallic layer is a continuous metallic layer. The functional coating further comprises a first primer layer over at least a portion of the first metallic layer. The functional coating further comprises a second dielectric layer over at least a portion of the first primer layer, wherein the second dielectric layer comprises a first film over at least a portion of the first primer layer and a second film over at least a portion of the first film. The functional coating further comprises a second metallic layer over at least a portion of the second film of the second dielectric layer, wherein the second metallic layer is a discontinuous metallic layer. The functional coating further comprises a second primer layer over at least a portion of the second metallic layer. The functional coating further comprises a third dielectric layer over at least a portion of the second primer layer. The functional coating further comprises a third metallic layer over at least a portion of the third dielectric layer, wherein the third metallic layer is a continuous metallic layer. The functional coating further comprises a third primer layer over at least a portion of the third metallic layer. The functional coating further comprises a fourth dielectric layer over at least a portion of the third primer layer. The functional coating further comprises a protective layer over at least a portion of the fourth dielectric layer. The coated article comprises an exterior reflectance b* (Rg b*) of 12>Rgb*>6. The coated article further comprises an interior reflectance of less than or equal to 16%. The coated article further comprises a visible light transmittance of at least 40%.

The coated article 10 comprises a substrate 12. The substrate 12 can be of any desired material having any desired characteristics, such as opaque, translucent, or transparent to visible light. For example, the substrate 12 can be transparent or translucent to visible light. By “transparent” is meant having visible light transmission of greater than 0% up to 100%. Alternatively, the substrate 12 can be translucent. By “translucent” is meant allowing electromagnetic energy (e.g., visible light) to pass through but diffusing this energy such that objects on the side opposite the viewer are not clearly visible. Examples of suitable materials include, but are not limited to, plastic substrates (such as acrylic polymers, such as polyacrylates; polyalkylmethacrylates, such as polymethylmethacrylates, polyethylmethacrylates, polypropylmethacrylates, and the like; polyurethanes; polycarbonates; polyalkylterephthalates, such as polyethyleneterephthalate (PET), polypropyleneterephthalates, polybutyleneterephthalates, and the like; polysiloxano-containing polymers; or copolymers of any monomers for preparing these, or any mixtures thereof); ceramic substrates; glass substrates; or mixtures or combinations of any of the above. For example, the substrate 12 can be conventional soda-lime-silicate glass, borosilicate glass, or leaded glass. The glass can be clear glass. By “clear glass” is meant non-tinted or non-colored glass. Alternatively, the glass can be tinted or otherwise colored glass. The glass can be annealed or heat-treated glass. As used herein, the term “heat treated” means tempered or at least partially tempered. The glass can be of any type, such as conventional float glass, and can be of any composition having any optical properties, e.g., any value of visible transmission, ultraviolet transmission, infrared transmission, and/or total solar energy transmission. By “float glass” is meant glass formed by a conventional float process in which molten glass is deposited onto a molten metal bath and controllably cooled to form a float glass ribbon. Examples of float glass processes are disclosed in U.S. Pat. Nos. 4,466,562 and 4,671,155.

The substrate 12 may comprise, for example, clear float glass or can be tinted or colored glass. The substrate 12 can be of any desired dimensions, e.g., length, width, shape, or thickness. In one non-limiting embodiment in which the substrate is an architectural transparency, the substrate 12 may be 1 mm to 30 mm thick, such as 2.5 mm to 25 mm thick, such as 2.5 mm to 10 mm. As used herein, the term “architectural transparency” refers to any transparency located on a building, such as, but not limited to, windows and sky lights. However, it is to be understood that the invention is not limited to use with such architectural transparencies but could be practiced with transparencies in any desired field, such as, but not limited to, laminated or non-laminated residential and/or commercial windows, insulating glass units, and/or transparencies for land, air, space, above water and underwater vehicles, as well as personal transparencies such as glasses and the like. Therefore, it is to be understood that the specifically disclosed exemplary embodiments are presented simply to explain the general concepts of the invention, and that the invention is not limited to these specific exemplary embodiments. Additionally, while a typical “transparency” can have sufficient visible light transmission such that materials can be viewed through the transparency, in the practice of the invention, the “transparency” need not be transparent to visible light but may be translucent or opaque.

In some embodiments, the substrate 12 can be a monolithic glazing. By “monolithic” is meant having a single structural support or structural member, e.g. having a single substrate.

The substrate 12 comprises a first surface 14 and a second surface 16. The second surface 16 is opposite the first surface 14.

The functional coatings 20 described herein can be deposited by any useful method, such as, but not limited to, conventional chemical vapor deposition (CVD) and/or physical vapor deposition (PVD) methods. Examples of CVD processes include spray pyrolysis. Examples of PVD processes include electron beam evaporation and vacuum sputtering (such as, magnetron sputter vapor deposition (MSVD)). Other coating methods could also be used, such as, but not limited to, sol-gel deposition, slot die coating deposition, or printing depositions, such as, screen printing or ink jet printing. In one non-limiting embodiment, the functional coating 20 is deposited by MSVD. Examples of MSVD coating devices and methods will be well understood by one of ordinary skill in the art and are described, for example, in U.S. Pat. Nos. 4,379,040; 4,861,669; 4,898,789; 4,898,790; 4,900,633; 4,920,006; 4,938,857; 5,328,768; and 5,492,750.

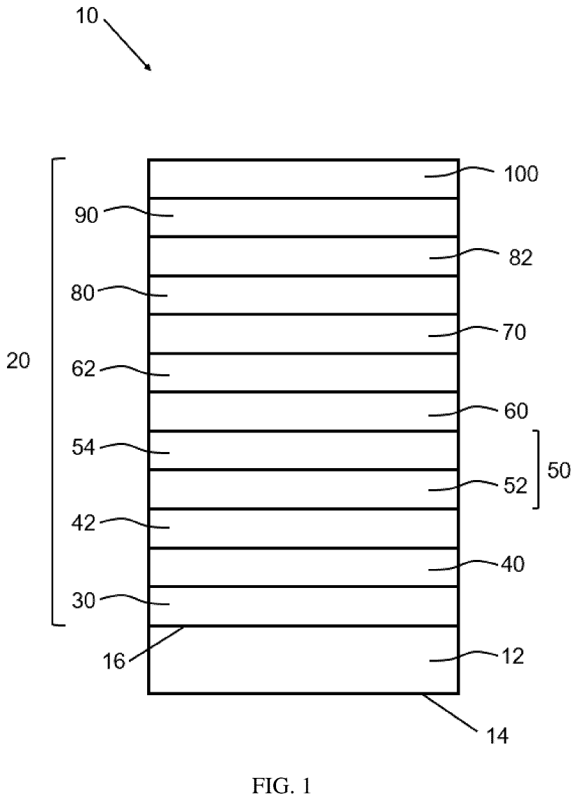

The functional coating 20 is positioned over at least a portion of the second surface 16 of the substrate 12. The functional coating 20 is a triple metal coating consisting of three metallic layers. An exemplary functional coating 20 is shown in FIG. 1.

The functional coating 20 includes a first dielectric layer 30 over or in direct contact with the second surface 16 of the substrate 12. The first dielectric layer 30 may be positioned over or in direct contact with a portion or the entire second surface 16 of the substrate 12. A first metallic layer 40 is positioned over or in direct contact with at least a portion of the first dielectric layer 30. The first metallic layer 40 is a continuous metallic layer. A first primer layer 42 is positioned over or in direct contact with at least a portion of the first metallic layer 40. A second dielectric layer 50 is positioned over or in direct contact with at least a portion of the first primer layer 42. The second dielectric layer 50 comprises a first film 52 positioned over or in direct contact with at least a portion of the first primer layer 42 and a second film 54 positioned over or in direct contact with at least a portion of the first film 52. A second metallic layer 60 is positioned over or in direct contact with at least a portion of the second film 54 of the second dielectric layer 50. The second metallic layer 60 is a discontinuous metallic layer. A second primer layer 62 is positioned over or in direct contact with at least a portion of the second metallic layer 60. A third dielectric layer 70 is positioned over or in direct contact with at least a portion of the second primer layer 62. A third metallic layer 80 is positioned over or in direct contact with at least a portion of the third dielectric layer 70. The third metallic layer 80 is a continuous metallic layer. A third primer layer 82 is positioned over or in direct contact with at least a portion of the third metallic layer 80. A fourth dielectric layer 90 is positioned over or in direct contact with at least a portion of the third primer layer 82. A protective layer 100 is positioned over or in direct contact with at least a portion of the fourth dielectric layer 90.

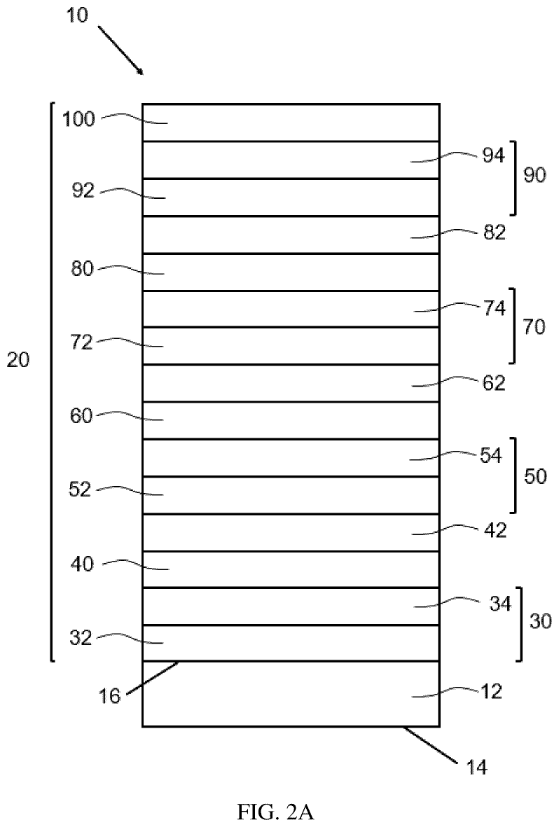

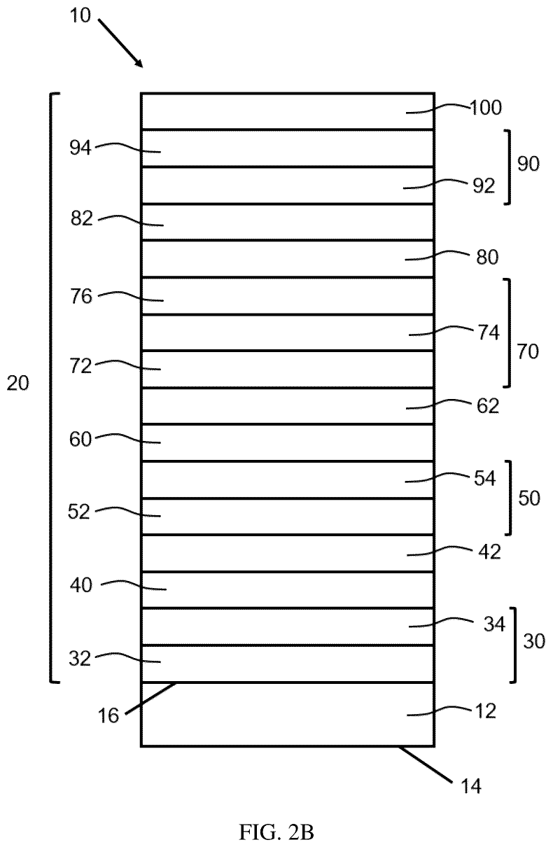

The functional coating 20 comprises a first dielectric layer 30 positioned over or in direct contact with the second surface 16 of the substrate 12. The first dielectric layer 30 may include a first film 32 positioned over or in direct contact with the second surface 16 of the substrate 12 and a second film 34 positioned over or in direct contact with the first film 32, as shown in FIGS. 2A and 2B. The first film 32 may be positioned over or in direct contact with a portion of the second surface 16 of the substrate 12 or the entire second surface 16 of the substrate 12. The first dielectric layer 30 can be transparent to visible light.

The first film 32 of the first dielectric layer 30 can comprise metal or metal alloy oxides, nitrides, oxynitrides, or mixtures thereof. Examples of suitable metal oxides, metal nitrides, and/or metal oxynitrides include oxides, nitrides, and/or oxynitrides of titanium, hafnium, zirconium, niobium, zinc, bismuth, lead, indium, tin, aluminum, silicon and mixtures thereof. The first film 32 of the first dielectric layer 30 may comprise silicon nitride (SiN), silicon oxide (SiO₂), silicon aluminum nitride (SiAlN), silicon aluminum oxide (SiAlO), silicon oxynitride (SiON), silicon aluminum oxynitride (SiAlON), zinc stannate, or tin oxide (SnO₂). The first film 32 of the first dielectric layer 30 may comprise SiN, SiAlN, or SnO₂.

If the first film 32 of the first dielectric layer 30 comprises silicon aluminum nitride, it may comprise from 5 wt. % to 20 wt. % aluminum and 95 wt. % to 80 wt. % silicon, such as 10 wt. % to 20 wt. % aluminum and 90 wt. % to 80 wt. % silicon, such as 20 wt. % to 25 wt. % aluminum and 80 wt. % to 75 wt. % silicon.

The first film 32 of the first dielectric layer 30 can comprise a total thickness in a range of from 20 nanometers (“nm”) to 36 nm, such as from 22 nm to 34 nm, such as from 24 nm to 31 nm, or such as from 25 nm to 31.5 nm. Alternatively, the first film 32 of the first dielectric layer 30 can comprise a total thickness in a range of from 15 nm to 30 nm, such as from 17 nm to 28 nm, such as from 18 nm to 25 nm, or such as from 19 nm to 23 nm.

The second film 34 of the first dielectric layer 30 can comprise materials, such as, but not limited to, metal or metal alloy oxides, nitrides, oxynitrides, or mixtures thereof. Examples of suitable metal oxides for the second film 34 of the first dielectric layer 30 include oxides of titanium, hafnium, zirconium, niobium, zinc, bismuth, lead, indium, tin, aluminum, silicon and mixtures thereof. These metal oxides can have small amounts of other materials, such as, manganese in bismuth oxide, tin in indium oxide, etc. Additionally, oxides of metal alloys or metal mixtures can be used, such as, oxides containing zinc and tin, oxides of indium-tin alloys, oxides containing zinc and aluminum, silicon nitrides, silicon aluminum nitrides, or aluminum nitrides.

For example, the second film 34 of the first dielectric layer 30 can be a zinc/tin alloy oxide. By “zinc/tin alloy oxide” is meant both true alloys, and mixtures of the oxides. The zinc target can include a small amount (e.g., up to 20 wt. %, up to 15 wt. %, up to 10 wt. %, or up to 5 wt. %) of tin to improve sputtering. In which case, the resultant zinc oxide film would include a small percentage of tin oxide, e.g., up to 20 wt. %, up to 15 wt. %, up to 10 wt. % tin oxide, or up to 5 wt. % tin oxide, wherein the remainder of the target is zinc. A coating layer deposited from a zinc target having up to 20 wt. % tin (or less) (added to enhance the conductivity of the target) is referred to herein as “a zinc oxide film” even though a small amount of tin may be present.

The second film 34 of the first dielectric layer 30 can comprise a total thickness in a range of from 4 nm to 14 nm, such as from 6 nm to 12 nm, such as from 7 nm to 10 nm, or such as from 7.5 nm to 9 nm. Alternatively, the second film 34 of the first dielectric layer 30 can comprise a total thickness in a range of from 3 nm to 16 nm, such as from 4 nm to 14 nm, such as from 5 nm to 12 nm, or such as from 6 nm to 10 nm.

The first film 32 of the first dielectric layer 30 may comprise tin oxide positioned over or in direct contact with the second surface 16 of the substrate 12 and the second film 34 of the first dielectric layer 30 may comprise zinc oxide positioned over or in direct contact with the first film 32. Alternatively, the first film 32 of the first dielectric layer 30 may comprise zinc stannate positioned over or in direct contact with the second surface 16 of the substrate 12 and the second film 34 of the first dielectric layer 30 may comprise zinc oxide positioned over or in direct contact with the first film 32.

The first dielectric layer 30 may comprise three films. The first dielectric layer 30 may include a first film 32 positioned over or in direct contact with the second surface 16 of the substrate 12, a second film 34 positioned over or in direct contact with the first film 32, and a third film positioned over or in direct contact with the second film 34.

The first film 32 of the first dielectric layer 30 may comprise tin oxide positioned over or in direct contact with the second surface 16 of the substrate 12, the second film 34 may comprise zinc stannate positioned over or in direct contact with the first film 32, and the third film may comprise zinc oxide positioned over or in direct contact with the second film 34.

The first dielectric layer 30 can comprise a total thickness (e.g., combined thickness of the first and second films 32, 34) in a range of from 24 nm to 50 nm, such as from 28 nm to 46 nm, such as from 31 nm to 41 nm, or such as from 32.5 nm to 40.5 nm. Alternatively, the first dielectric layer 30 can comprise a total thickness (e.g., combined thickness of the first and second films 32, 34) in a range of from 18 nm to 46 nm, such as from 21 nm to 42 nm, such as from 23 nm to 37 nm, or such as from 25 nm to 33 nm.

A first metallic layer 40 is positioned over or in direct contact with at least a portion of the first dielectric layer 30, such as over or in direct contact with at least a portion of the second film 34 or the optional third film of the first dielectric layer 30. The first metallic layer 40 can include a reflective metal, such as, but not limited to, metallic gold, copper, palladium, aluminum, silver, or mixtures, alloys, or combinations thereof. For example, the first metallic layer 40 comprises a metallic silver layer. The first metallic layer 40 is a continuous layer. By “continuous layer” is meant that the coating has a thickness above the percolation threshold.

The first metallic layer 40 can comprise a thickness in a range of from 15 nm to 25 nm, such as from 16 nm to 22 nm, such as from 17 nm to 23 nm, or such as from 18.5 nm to 22 nm. Alternatively, the first metallic layer 40 can comprise a thickness in a range of from 10 nm to 26 nm, such as from 12 nm to 24 nm, such as from 14 nm to 22 nm, or such as from 16 nm to 20 nm.

A first primer layer 42 is positioned over or in direct contact with the first metallic layer 40. The first primer layer 42 can be a single film or a multiple film layer. The first primer layer 42 can include an oxygen-capturing material that can be sacrificial during the deposition process to prevent degradation or oxidation of the metallic layer 40 during the sputtering process or subsequent heating processes. The first primer layer 42 can also absorb at least a portion of electromagnetic radiation, such as, visible light, passing through the functional coating 20. Examples of materials useful for the first primer layer 42 include titanium, cobalt, silicon, zinc, aluminum, vanadium, tungsten, tantalum, niobium, zirconium, manganese, chromium, tin, nickel, gallium, indium, germanium, magnesium, molybdenum, silver, silicon carbide, aluminum-doped silver aluminum zinc, vanadium zinc, tungsten tantalum, titanium niobium, zirconium niobium, tungsten niobium, aluminum niobium, aluminum titanium, tungsten titanium, tantalum titanium, zinc titanium, aluminum silver, zinc tin, indium zinc, silver zinc, mixtures thereof, and alloys thereof. For example, the first primer layer 42 may comprise titanium, titanium and aluminum, zinc and aluminum, nickel chrome (e.g. Inconel®) or cobalt chrome (e.g. Stellite®) which is deposited as a metal and at least a portion of the primer is subsequently oxidized.

The first primer layer 42 can comprise a thickness in the range of from 1 nm to 5 nm, such as from 1.5 nm to 4.5 nm, such as from 2 nm to 4 nm, or such as from 2.5 nm to 3.5 nm.

A second dielectric layer 50 is positioned over or in direct contact with at least a portion of the first primer layer 42. The second dielectric layer 50 comprises a first film 52 over or in direct contact with at least a portion of the first primer layer 42 and a second film 54 over or in direct contact with at least a portion of the first film 52. For example, the second dielectric layer consists of a first film 52 and a second film 54.

The first film 52 and the second film 54 of the second dielectric layer 50 can comprise one or more metal oxide, metal alloy oxide, metal nitride, metal alloy nitride, metal oxynitride, or metal alloy oxynitride-containing films, such as those described above with respect to the first film 32 and second film 34 of the first dielectric layer 30. For example, the first film 52 of the second dielectric layer 50 can comprise a metal oxide, e.g., a zinc oxide, deposited over at least a portion of the first primer layer 42. For example, the second film 54 of the second dielectric layer 50 can comprise a metal alloy oxide, e.g., a zinc stannate film over at least a portion of the first film 52. By “zinc stannate” is meant a composition of ZnxSn₁₋ₓO₂₋ₓ (Formula 1) where “x” varies in the range of greater than 0 to less than 1. For instance, “x” can be greater than 0 and can be any fraction or decimal between greater than 0 to less than 1. For example, where x=⅔, Formula 1 is Zn_{2/3}Sn_{1/3}O_{4/3}, which is more commonly described as “Zn₂SnO₄”. A zinc stannate-containing film has one or more of the forms of Formula 1 in a predominant amount in the layer.

The first film 52 of the second dielectric layer 50 can comprise a thickness in a range of from 3 nm to 11 nm, such as from 5 nm to 10 nm, such as from 6 nm to 9 nm, or such as from 6.5 nm to 8 nm.

The second film 54 of the second dielectric layer 50 can comprise a thickness in a range of from 2 nm to 12 nm, such as from 3 nm to 11 nm, such as from 4 nm to 10 nm, or such as from 4.5 nm to 9 nm. Alternatively, the second film 54 of the second dielectric layer 50 can comprise a thickness in a range of from 20 nm to 36 nm, such as from 22 nm to 34 nm, such as from 24 nm to 32 nm, or such as from 26 nm to 30 nm.

The second dielectric layer 50 can comprise a total thickness (e.g., the combined thicknesses of the first film 52 and the second film 54) in the range of from 5 nm to 23 nm, such as from 8 nm to 21 nm, such as from 10 nm to 19 nm, or such as from 11 nm to 17 nm. Alternatively, the second dielectric layer 50 can comprise a total thickness (e.g., the combined thicknesses of the first film 52 and the second film 54) in the range of from 23 nm to 47 nm, such as from 27 nm to 44 nm, such as from 30 nm to 41 nm, or such as from 32.5 nm to 38 nm

A second metallic layer 60 is positioned over or in direct contact with at least a portion of the second dielectric layer 50, such as over or in direct contact with at least a portion of the second film 54 of the second dielectric layer 50. The second metallic layer 60 can include a reflective metal, such as, but not limited to, metallic gold, copper, palladium, aluminum, silver, or mixtures, alloys, or combinations thereof. For example, the second metallic layer 60 comprises a metallic silver layer.

The second metallic layer 60 is a discontinuous metallic layer. To form the discontinuous layer, the metallic layer is applied below the percolation threshold such that a discontinuous film is formed, rather than a continuous layer of the material. The second metallic layer 60 absorbs electromagnetic radiation according to the Plasmon Resonance Theory. This absorption depends at least partly on the boundary conditions at the interface of the metallic islands. The second metallic layer 60 is not an infrared reflecting layer, like the first metallic layer 40.

The second metallic layer 60 can comprise a thickness in a range of from 0.2 nm to 5 nm, such as from 0.5 nm to 4 nm, such as from 1 nm to 3 nm, or such as from 1.5 nm to 2.5 nm. Alternatively, the second metallic layer 60 can comprise a thickness in a range of from 0.2 nm to 5 nm, such as from 0.3 nm to 4 nm, such as from 0.4 nm to 3 nm, or such as from 0.5 nm to 2 nm.

A second primer layer 62 is positioned over or in direct contact with at least a portion of the second metallic layer 60. The second primer layer 62 can be a single film or a multiple layer film. The second primer layer 62 can include an oxygen-capturing material that can be sacrificial during the deposition process to prevent degradation or oxidation of the second primer layer 62 during the sputtering process or subsequent heating processes. Examples of materials useful for the second primer layer 62 are the same as the first primer layer 42. For example, the second primer layer 62 may comprise titanium.

The second primer layer 62 is thinner than the first primer layer 42. The second primer layer 62 may be a discontinuous primer layer. The second primer layer 62 can comprise a thickness in a range of from 0.2 nm to 4 nm, such as from 0.5 nm to 3.5 nm, such as from 0.7 nm to 3 nm, or such as from 1 nm to 2.5 nm. Alternatively, the second primer layer 62 can comprise a thickness in the range of from 0.5 nm to 6 nm, such as from 1 nm to 5.5 nm, such as from 2 nm to 5 nm, or such as from 2.5 nm to 4.5 nm.

A third dielectric layer 70 is positioned over or in direct contact with at least a portion of the second primer layer 62. The third dielectric layer 70 may comprise a first film 72 over or in direct contact with at least a portion of the second primer layer 62 and a second film 74 over or in direct contact with at least a portion of the first film 72 (FIG. 2A). Alternatively, the third dielectric layer 70 may comprise a first film 72 over or in direct contact with at least a portion of the second primer layer 62, a second film 74 over or in direct contact with at least a portion of the first film 72, and a third film 76 over or in direct contact with at least a portion of the second film 76 (FIG. 2B).

The first film 72, the second film 74, and the third film 76, when present, of the third dielectric layer 70 can comprise one or more metal oxide, metal alloy oxide, metal nitride, metal alloy nitride, metal oxynitride, or metal alloy oxynitride-containing films, such as those described above with respect to the first film 32 and second film 34 of the first dielectric layer 30.

For example, when the third dielectric layer 70 includes a first film 72 and a second film 74, the first film 72 of the third dielectric layer 70 may comprise a metal alloy oxide, e.g., a zinc stannate film, deposited over at least a portion of the second primer layer 62 and the second film 74 of the third dielectric layer 70 may comprise a metal oxide, e.g., a zinc oxide or tin oxide film, over at least a portion of the first film 72. When the third dielectric layer 70 comprises a first film 72 and a second film 74, the first film 72 of the third dielectric layer 70 can comprise a thickness in the range of from 45 nm to 57 nm, such as from 48 nm to 55 nm, such as from 50 nm to 54 nm, or such as from 51 nm to 53 nm.

When the third dielectric layer 70 comprises a first film 72 and a second film 74, the second film 74 of the third dielectric layer 70 can comprise a thickness in the range of from 4 nm to 11 nm, such as from 5 nm to 10 nm, such as from 5.5 nm to 9 nm, or such as from 6 nm to 8.5 nm.

When the third dielectric layer 70 comprises a first film 72 and a second film 74, the third dielectric layer 70 can comprise a total thickness (e.g., the combined thicknesses of the first film 72 and the second film 74) in a range of from 49 nm to 68 nm, such as from 53 nm to 65 nm, such as from 55.5 nm to 63 nm, or such as from 57 nm to 61.5 nm.

Alternatively, when the third dielectric layer 70 includes a first film 72, a second film 74, and a third film 76, the first film 72 of the third dielectric layer 70 may comprise a metal oxide, e.g., a zinc oxide or tin oxide film, over at least a portion of the second primer layer 62, the second film 74 of the third dielectric layer 70 may comprise a metal alloy oxide, e.g., a zinc stannate film, deposited over at least a portion of the first film 72, and the third film 76 of the third dielectric layer 70 may comprise a metal oxide, e.g., a zinc oxide or tin oxide film, over at least a portion of the second film 74.

When the third dielectric layer 70 comprises a first film 72, a second film 74, and a third film 76, the first film 72 of the third dielectric layer 70 can comprise a thickness in the range of from 3 nm to 16 nm, such as from 4 nm to 14 nm, such as from 5 nm to 12 nm, or such as from 6 nm to 10 nm.

When the third dielectric layer 70 comprises a first film 72, a second film 74, and a third film 76, the second film 74 of the third dielectric layer 70 can comprise a thickness in the range of from 28 nm to 42 nm, such as from 30 nm to 40 nm, such as from 32 nm to 38 nm, or such as from 34 nm to 36 nm.

When the third dielectric layer 70 comprises a first film 72, a second film 74, and a third film 76, the third film 76 of the third dielectric layer 70 can comprise a thickness in the range of from 3 nm to 16 nm, such as from 4 nm to 14 nm, such as from 5 nm to 12 nm, or such as from 6 nm to 10 nm.

When the third dielectric layer 70 comprises a first film 72, second film 74, and third film 76, the third dielectric layer 70 can comprise a total thickness (i.e., the combined thickness of the first film 72, second film 74, and third film 76) in a range of from 34 nm to 74 nm, such as from 38 nm to 68 nm, such as from 42 nm to 62 nm, or such as from 46 nm to 56 nm.

A third metallic layer 80 is positioned over or in direct contact with the third dielectric layer 70, such as over at least a portion of the second film 74 of the third dielectric layer 70 or the third film 76 of the third dielectric layer 70. The third metallic layer 80 can include a reflective metal, such as, but not limited to, metallic gold, copper, palladium, aluminum, silver, or mixtures, alloys, or combinations thereof. For example, the third metallic layer 80 comprises a metallic silver layer. The third metallic layer 80 is a continuous layer.

The third metallic layer 80 can comprise a thickness in a range of from 9 nm to 16 nm, such as from 10 nm to 15 nm, such as from 11 nm to 14.5 nm, or such as from 11.5 nm to 14 nm.

A third primer layer 82 is positioned over or in direct contact with at least a portion of the third metallic layer 80. The third primer layer 82 can be a single film or a multiple layer film. The third primer layer 82 can include an oxygen-capturing material that can be sacrificial during the deposition process to prevent degradation or oxidation of the third primer layer 82 during the sputtering process or subsequent heating processes. Examples of materials useful for the third primer layer 82 are the same as the first primer layer 42.

The third primer layer 82 is thicker than the second primer layer 62. The third primer layer 82 may be the same thickness as the first primer layer 42.

The third primer layer 82 can comprise a thickness in a range of from 1 nm to 5 nm, such as from 1.5 nm to 4.5 nm, such as from 2 nm to 4 nm, or such as from 2.5 nm to 3.5 nm.

A fourth dielectric layer 90 is positioned over or in direct contact with at least a portion of the third primer layer 82. The fourth dielectric layer 40 may include a first film 92 positioned over or in direct contact with the third primer layer 82 and a second film 94 positioned over or in direct contact with the first film 92, as shown in FIGS. 2A and 2B.

The first film 92 and the second film 94 of the fourth dielectric layer 90 can comprise one or more metal oxide, metal alloy oxide, metal nitride, metal alloy nitride, metal oxynitride, or metal alloy oxynitride-containing films, such as those described above with respect to the first film 32 and second film 34 of the first dielectric layer 30. For example, the first film 92 of the fourth dielectric layer 90 comprises a metal oxide, e.g., a zinc oxide, deposited over at least a portion of the third primer layer 82. For example, the second film 94 of the fourth dielectric layer 90 comprises a metal alloy oxide or a metal oxide, e.g., a zinc stannate or tin oxide film, over at least a portion of the first film 72.

The first film 92 of the fourth dielectric layer 90 can comprise a thickness in a range of 4 nm to 14 nm, such as from 6 nm to 12 nm, such as from 7 nm to 10 nm, or such as from 7.5 nm to 9 nm.

The second film 94 of the fourth dielectric layer 90 can comprise a thickness in the range of from second film of the fourth dielectric layer comprises a thickness in a range of from 12 nm to 24 nm, such as from 14 nm to 22 nm, such as from 12 nm to 16 nm, or such as from 19 nm to 21 nm.

The fourth dielectric layer 90 can comprise a total thickness (e.g., the combined thicknesses of the first film 92 and the second film 94) in a range of from 16 nm to 38 nm, such as from 20 nm to 34 nm, such as from 19 nm to 26 nm, or such as from 26.5 nm to 30 nm.

A protective layer 100 is positioned over or in direct contact with the fourth dielectric layer 90, such as the second film 94 of the fourth dielectric layer 90. The protective layer 100 is the outermost layer of the functional coating 20. The protective layer 100 can help protect the underlying functional coating layers, from mechanical and/or chemical attack. The protective layer 100 can be an oxygen barrier coating layer to prevent or reduce the passage of ambient oxygen into the underlying layers of the coating, such as, during heating or bending. The protective layer 100 can be of any desired material or mixture of materials and can be comprised of one or more protective films. The protective layer 100 may comprise at least one of Si₃N₄, SIAlN, SiAlON, SiAlO, TiAlO, titania (TiO₂), alumina (Al₂O₃), silica (SiO₂), zirconia (ZrO₂), or combinations thereof. For example, the protective layer 100 may comprise a single film of titania.

The protective layer 100 may comprise a total thickness in a range of from 1 nm to 6 nm, such as from 2 nm to 5 nm, or such as from 3 nm to 4 nm. Alternatively, the protective layer 100 may comprise a thickness in the range of from 1 nm to 76 nm, such as from 2 nm to 65 nm, or such as from 3 nm to 5 nm.

The protective layer 100 may comprise a multi-layer structure, e.g., a first protective layer with at least one second protective layer formed over the first protective layer. For example, the first protective layer can comprise alumina or a mixture or alloy comprising alumina and silica. For example, the first protective layer can comprise a silica/alumina mixture having greater than 5 wt. % alumina, such as greater than 10 wt. % alumina, such as greater than 15 wt. % alumina, such as greater than 30 wt. % alumina, such as greater than 40 wt. % alumina, such as 50 wt. % to 70 wt. % alumina, such as in the range of 70 wt. % to 100 wt. % alumina and 30 wt. % to 0 wt. % silica, such as greater than 90 wt. % alumina, such as greater than 95 wt. % alumina. Alternatively, the first protective layer may comprise all or substantially all alumina. The second protective layer can comprise silica or a mixture or alloy comprising silica and alumina. For example, the second protective layer can comprise a silica/alumina mixture having greater than 40 wt. % silica, such as greater than 50 wt. % silica, such as greater than 60 wt. % silica, such as greater than 70 wt. % silica, such as greater than 80 wt. % silica, such as in the range of 80 wt. % to 90 wt. % silica and 10 wt. % to 20 wt. % alumina, e.g., 85 wt. % silica and 15 wt. % alumina.

The functional coating 20 can be a functional coating according to Table 1.

TABLE 1

| Layer | Exemplary Material | Thickness |
|---|---|---|
| First | First Film: SiN, SiO₂, SiAlN, | 24-50 nm; |
| Di- | SiAlO, SiON, SiAlON, | preferably 28-46 nm; |
| electric | Zn₂SnO₄, SnO₂ | more preferably 31-41 nm; |
| Layer | Second Film: ZnO, AlZnO | most preferably 32.5- |
| | | 40.5 nm |
| First | Au, Cu, Pd, Cu, Al, and/or Ag | 15-25 nm; |
| Metallic | | preferably 16-22 nm; |
| Layer | | more preferably 17-23 nm; |
| | | most preferably 18.5-22 nm |
| First | Ti, TiAl, NiCr, CoCr, AlZn | 1-5 nm |
| Primer | | preferably 1.5-4.5 nm, |
| Layer | | more preferably 2-4 nm |
| | | most preferably 2.5-3.5 nm |
| Second | First Film: ZnO, AlZnO | 5-23 nm; |
| Di- | Second Film: Zn₂SnO₄ | preferably 8-21 nm; |
| electric | | more preferably 10-19 nm; |
| Layer | | most preferably 11-17 nm |
| Second | Au, Cu, Pd, Cu, Al, and/or Ag | 0.2-5 nm; |
| Metallic | | preferably 0.5-4 nm; |
| Layer | | more preferably 1-3 nm; |
| | | most preferably 1.5-2.5 nm |
| Second | Ti, TiAl, NiCr, CoCr, AlZn | 0.2-4 nm; |
| Primer | | preferably 0.5-3.5 nm; |
| Layer | | more preferably 0.7-3 nm; |
| | | most preferably 1-2.5 nm |
| Third | First Film: Zn₂SnO₄ | 49-68 nm; |
| Di- | Second Film: ZnO, AlZnO | preferably 53-65 nm; |
| electric | | more preferably 55.5- |
| Layer | | 63 nm; most preferably |
| | | 57-61.5 nm |
| Third | Au, Cu, Pd, Cu, Al, and/or Ag | 9-16 nm; |
| Metallic | | preferably 10-15 nm; |
| Layer | | more preferably 11- |
| | | 14.5 nm; most preferably |
| | | 11.5-14 nm |
| Third | Ti, TiAl, NiCr, CoCr, AlZn | 1-5 nm; |
| Primer | | preferably1.5-4.5 nm; |
| Layer | | more preferably 2-4 nm; |
| | | most preferably 2.5-3.5 nm |
| Fourth | First Film: ZnO, AlZnO | 16-38 nm; |
| Di- | Second Film: Zn₂SnO₄ or SnO₂ | preferably 20-34 nm; |
| electric | | most preferably 19-26 nm; |
| Layer | | more preferably 26.5-30 nm |
| Pro- | Si₃N₄, SiAlON, SiAlON, SiAlO, | 1-6 nm |
| tective | TiAlO, TiO₂, Al₂O₃, SiO₂, and/or | preferably 2-5 nm; |
| Layer | ZrO₂ | more preferably 3-4 nm |

The functional coating 20 can be a functional coating according to Table 2.

TABLE 2

| Layer | Exemplary Material | Thickness |
|---|---|---|
| First | First Film: SiN, SiO₂, SiAlN, | 18-46 nm; |
| Di- | SiAlO, SiON, SiAlON, | preferably 21-42 nm; |
| electric | Zn₂SnO₄, SnO₂ | more preferably 23-37 nm; |
| Layer | Second Film: ZnO, AlZnO | most preferably 25-33 nm |
| First | Au, Cu, Pd, Cu, Al, and/or Ag | 10-26 nm; |
| Metallic | | preferably 12-24 nm; |
| Layer | | more preferably 14-22 nm; |
| | | most preferably 16-20 nm |
| First | Ti, TiAl, NiCr, CoCr, AlZn | 1-5 nm |
| Primer | | preferably 1.5-4.5 nm, |
| Layer | | more preferably 2-4 nm |
| | | most preferably 2.5-3.5 nm |
| Second | First Film: ZnO, AlZnO | 23-47 nm; |
| Di- | Second Film: Zn₂SnO₄ | preferably 27-44 nm; |
| electric | | more preferably 30-41 nm; |
| Layer | | most preferably 32.5-38 nm |
| Second | Au, Cu, Pd, Cu, Al, and/or Ag | 0.2-5 nm; |
| Metallic | | preferably 0.3-4 nm; |
| Layer | | more preferably 0.4-3 nm; |
| | | most preferably 0.5-2 nm |
| Second | Ti, TiAl, NiCr, CoCr, AlZn | 0.5-6 nm; |
| Primer | | preferably 1-5.5 nm; |
| Layer | | more preferably 2-5 nm; |
| | | most preferably 2.5-4.5 nm |
| Third | First Film: ZnO, AlZnO | 34-74 nm; |
| Di- | Second Film: Zn₂SnO₄ | preferably 38-68 nm; |
| electric | Third Film: ZnO, AlZnO | more preferably 42-62 nm; |
| Layer | | most preferably 46-56 nm |
| Third | Au, Cu, Pd, Cu, Al, and/or Ag | 9-16 nm; |
| Metallic | | preferably 10-15 nm; |
| Layer | | more preferably 11-14.5 nm; |
| | | most preferably 11.5-14 nm |
| Third | Ti, TiAl, NiCr, CoCr, AlZn | 1-5 nm; |
| Primer | | preferably 1.5-4.5 nm; |
| Layer | | more preferably 2-4 nm; |
| | | most preferably 2.5-3.5 nm |
| Fourth | First Film: ZnO, AlZnO | 16-38 nm; |
| Di- | | preferably 20-34 nm; |
| electric | Second Film: Zn₂SnO₄ or SnO₂ | most preferably 19-26 nm; |
| Layer | | more preferably 26.5-30 nm |
| Pro- | Si₃N₄, SiAlON, SiAlON, SiAlO, | 1-7 nm |
| tective | TiAlO, TiO₂, Al₂O₃, SiO₂, | preferably 2-6 nm; |
| Layer | and/or ZrO₂ | more preferably 3-5 nm |

As will be appreciated by one of skill in the art, the color of an object, and in particular glass, is highly subjective. Observed color will depend on the lighting conditions and preferences of the observer. The CIELAB color system, specified by the International Commission on Illumination, was developed in order to evaluate color on a quantitative basis, which specifies the color in terms of hue and lightness. Hue distinguishes colors such as red, yellow, green and blue. Lightness, or value, distinguishes the degree of lightness or darkness. The numerical values of these characteristics, which are identified as L*, a* and b*, are calculated from the tristimulus values (X, Y, Z). L* indicates the lightness or darkness of the color and represents the lightness plane on which the color resides. a* indicates the position of the color on a red (+a*) green (−a*) axis. b* indicates the color position on a yellow (+b*) blue (−b*) axis. When the rectangular coordinates of the CIELAB system are converted into cylindrical polar coordinates, the resulting color system is known as the CIELCH color system which specifies color in terms of lightness (L*), and hue angle (Hº) and chroma (C*). L* indicates the lightness or darkness of the color as in the CIELAB system. Chroma, or saturation or intensity, distinguishes color intensity or clarity (i.e. vividness vs. dullness) and is the vector distance from the center of the color space to the measured color. The lower the chroma of the color, i.e. the less its intensity, the closer the color is to being a so-called neutral color. With respect to the CIELAB system, C*=(a*2+b*2) ½. Hue angle distinguishes colors such as red, yellow, green and blue and is a measure of the angle of the vector extending from the a*, b* coordinates through the center of the CIELCH color space measured counterclockwise from the red (+a*) axis.

The functional coating 20 provides the coated article 10 with an exterior reflectance b* (Rg b*) of 12>Rg b*>6. For example, the functional coating 20 may provide the coated article 10 with a Rg b* of 11.5>Rgb*>6, such as 11>Rgb*>6, such as 11.5>Rgb*>9, such as, or such as 10>Rgb*>7. The Rg b* is determined at an incident angle of 8 degrees) (° relative to normal of the coated article 10. As used herein the “incident angle” is defined as the angle between a ray of radiation incident on a surface of the article to a line normal to the surface at the point of incidence.

The functional coating 20 provides the coated article 10 with an exterior reflectance a* (Rg a*) of −2.5<Rg a*<2.5. For example, the functional coating 20 may provide the coated article 10 with a Rg a* of −2<Rg a*<2, or such as −1<Rg a*<1. The Rg a* is determined at an incident angle of 8° relative to normal of the coated article 10.

The functional coating 20 provides the coated article 10 with an interior reflectance a* (Rf a*) of −8<Rf a*<5. For example, the functional coating 20 may provide the coated article 10 with a Rf a* of −7<Rf a*<4. The Rf a* is determined at an incident angle of 8° relative to normal of the coated article 10.

The functional coating 20 provides the coated article 10 with an interior reflectance b* (Rf b*) of −17<Rf b*<3. For example, the functional coating 20 may provide the coated article 10 with a Rf b* of −14<Rf b*<2. The Rf b* is determined at an incident angle of 8° relative to normal of the coated article 10.

The functional coating 20 provides the coated article 10 with a transmitted a* (T a*) of −12<T a*<0. For example, the functional coating 20 may provide the coated article 10 with a T a* of −7<T a*<−1. The T a* is determined at an incident angle of 8° relative to normal of the coated article 10.

The functional coating 20 provides the coated article 10 with a transmitted b* (T b*) of −7<T b*<10. For example, the functional coating 20 may provide the coated article 10 with a T b* of −6<T b*<9.5. The T b* is determined at an incident angle of 8° relative to normal of the coated article 10.

For example, the functional coating 20 may provide the coated article 10 with a Rg a* of −2<Rg a*<2, a Rg b* of 11>Rg b*>6, a Rf a* of −8<Rf a*<5, a Rf b* of −17<Rf b*<3, a T a* of −12<T a*<0, and a T b* of −7<T b*<10.

For example, the article 10 may comprise a Rg a* of −1<Rg a*<1, a Rg b* of 10>Rgb*>7, a Rf a* of −7<Rf a*<4, a Rf b* of −14<Rf b*<2, a Ta* of −7<Ta*<−1, and a T b* of −6<T b*<9.5.

The functional coating 20 provides the coated article 10 with an interior reflectance of less than or equal to 16%. For example, the functional coating 20 may provide the coated article 10 with an interior reflectance of from 6% to 16%, or such as 8% to 16%.

The functional coating 20 provides the coated article 10 with a visible light transmittance of at least 40%. For example, the functional coating 20 provides the coated article 10 with a visible light transmittance in a range of from 40% to 50%.

The functional coating 20 provides the coated article 10 with an exterior reflectance in a range from 20% to 40%. Alternatively, the functional coating 20 may provide the coated article 10 with an exterior reflectance of not greater than 26%. For example, the functional coating 20 may provide the coated article 10 with an exterior reflectance in a range of from 25% to 26%. Alternatively, the functional coating 20 may provide the coated article 10 with an exterior reflectance of at least 30%. Alternatively, the functional coating 20 may provide the coated article 10 with an exterior reflectance of at least 35%.

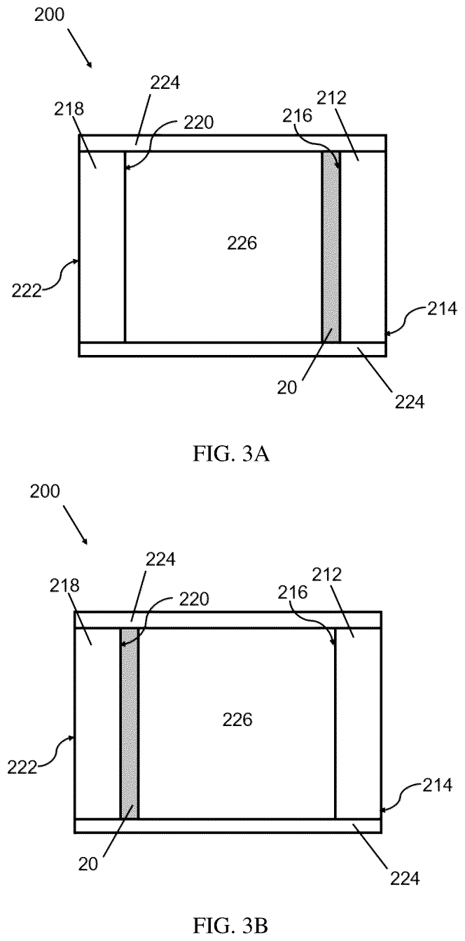

The present invention is also directed to a coated transparency 200. For example, the coated transparency 200 may be used an architectural transparency or architectural glazing, such as, but not limited to, an insulating glass unit. Non-limiting coated transparencies 200 as insulating glass units incorporating the features of the invention are provided in FIGS. 3A and 3B. The coated transparency 200 comprises a first substrate 212 comprising a No. 1 surface 214 and a No. 2 surface 216 opposite the No. 1 surface 214 and a second substrate 218 comprising a No. 3 surface 220 and No. 4 surface 222 opposite the No. 3 surface 220. In the illustrated non-limiting embodiment, the No. 1 surface 214 of the first substrate 212 faces the building exterior, i.e., is an outer major surface, and the No. 2 surface 216 faces the interior of the building. The second substrate 118 is spaced apart from the first substrate 212. The No. 3 surface 220 faces the No. 2 surface 216. In some embodiments, the coated transparency 200 may further comprise a third substrate with a No. 5 surface and No. 6 surface opposite the No. 5 surface. The substrates 212, 218 can have any desired visible light, infrared radiation, or ultraviolet radiation transmission and/or reflection. For example, the substrates 212, 218 can have a visible light transmission of any desired amount, e.g., greater than 0% up to 100%. The substrates 212, 218 can each be, for example, clear float glass or can be tinted or colored glass or one substrate 212, 218 can be clear glass and the other substrate 212, 218 colored glass. Although not limiting to the invention, examples of glass suitable for the first substrate 212 and/or second substrate 218 are described in U.S. Pat. Nos. 4,746,347; 4,792,536; 5,030,593; 5,030,594; 5,240,886; 5,385,872; and 5,393,593. Examples of insulating glass units are found, for example, in U.S. Pat. Nos. 4,193,236; 4,464,874; 5,088,258; and 5,106,663.

The first substrate 212 and the second substrate 218 are connected together in any suitable matter, such as, by being adhesively bonded to a conventional spacer frame 224. A gap or chamber 226 is formed between the first substrate 212 and the second substrate 218. The chamber 226 can be filled with a selected atmosphere, such as, air, or a non-reactive gas such as, argon or krypton gas.

A functional coating 20 as described above is positioned over or in direct contact with at least a portion of the No. 2 surface 216 of the first substrate 212 or the No. 3 surface 220 of the second substrate 218. The functional coating 20 may comprise, consist essentially of, or consist of any of the functional coatings described herein. The functional coating 20 may be over at least a portion of the No. 2 surface 216 of the first substrate 212, as shown in FIG. 3A. Alternatively, the functional coating 20 may be over at least a portion of the No. 3 surface 220 of the second substrate 218, as shown in FIG. 3B. The functional coating 20 is not over the No. 1 surface 214 of the first substrate 212. The functional coating 20 is not over the No. 4 surface 222 of the second substrate 118.

The functional coating 20 provides the coated transparency 200 with an exterior reflectance Rg b* of 12>Rgb*>6. For example, the functional coating 20 may provide the coated transparency 200 with a Rg b* of 11.5>Rg b*>6, such as 11>Rg b*>6, such as 11.5>Rg b*>9, such as, or such as 10>Rgb*>7. The Rg b* is determined at an incident angle of 8° relative to normal of the coated transparency 200.

The functional coating 20 provides the coated transparency 200 with an exterior reflectance a* (Rg a*) of −2.5<Rg a*<2.5. For example, the functional coating 20 may provide the coated transparency 200 with a Rg a* of −2<Rg a*<2, or such as −1<Rg a*<1. The Rg a* is determined at an incident angle of 8° relative to normal of the coated transparency 200.

The functional coating 20 provides the coated transparency 200 with an interior reflectance a* (Rf a*) of −8<Rf a*<5. For example, the functional coating 20 may provide the coated transparency 200 with a Rf a* of −7<Rf a*<4. The Rf a* is determined at an incident angle of 8° relative to normal of the coated transparency 200.

The functional coating 20 provides the coated transparency 200 with an interior reflectance b* (Rf b*) of −17<Rf b*<3. For example, the functional coating 20 may provide the coated transparency 200 with a Rf b* of −14<Rf b*<2. The Rf b* is determined at an incident angle of 8° relative to normal of the coated transparency 200.

The functional coating 20 provides the coated transparency 200 with a transmitted a* (T a*) of −12<T a*<0. For example, the functional coating 20 may provide the coated transparency 200 with a T a* of −7<T a*<−1. The T a* is determined at an incident angle of 8° relative to normal of the coated transparency 200.

The functional coating 20 provides the coated transparency 200 with a transmitted b* (T b*) of −7<T b*<12. For example, the functional coating 20 may provide the coated transparency 200 with a T b* of −5.5<Tb*<10. The T b* is determined at an incident angle of 8° relative to normal of the coated transparency 200.

For example, the functional coating 20 may provide the coated transparency with a Rg a* of −2<Rg a*<2, a Rg b* of 11>Rg b*>6, a Rf a* of −8<Rf a*<5, a Rf b* of −17<Rf b*<3, a T a* of −12<T a*<0, and a T b* of −7<Tb*<10.

For example, the functional coating 20 may provide the coated transparency 200 with a Rg a* of −1<Rg a*<1, a Rg b* of 10>Rg b*>7, a Rf a* of −7<Rf a*<4, a Rf b* of −14<Rf b*<2, a T a* of −7<Ta*<−1, and a Tb* of −6<Tb*<9.5.

The functional coating 20 provides the coated transparency 200 with an interior reflectance of less than or equal to 16%. For example, the functional coating 20 may provide the coated transparency 200 with an interior reflectance of from 6% to 16%, or such as from 8% to 16%.

The functional coating 20 provides the coated transparency 200 with a visible light transmittance of at least 40%. For example, the functional coating 20 provides the coated transparency 200 with a visible light transmittance in a range of from 40% to 50%.

The functional coating 20 provides the coated transparency 200 with an exterior reflectance in a range from 20% to 40%. Alternatively, the functional coating 20 may provide the coated transparency 200 with an exterior reflectance of not greater than 26%. For example, the functional coating 20 may provide the coated transparency 200 with an exterior reflectance in a range of from 25% to 26%. Alternatively, the functional coating 20 may provide the coated transparency 200 with an exterior reflectance of at least 30%. Alternatively, the functional coating 20 may provide the coated transparency 200 with an exterior reflectance of at least 35%.

The present invention is also directed to a method of making a coated article. A substrate 12 comprising a first surface 14 and a second surface 16 opposite the first surface 14 is provided. The substrate 12 may be any of the substrates described herein. A functional coating 20 is formed over or in direct contact with at least a portion of the second surface 16 of the substrate 12. The functional coating 20 may comprise, consist essentially of, or consist of any of the functional coatings described herein.

The following numbered clauses are illustrative of various aspects of the invention:

Clause 1: A coated article comprising: a substrate comprising a first surface and a second surface opposite the first surface; and a functional coating over at least a portion of the second surface of the substrate, the functional coating comprising: a first dielectric layer over at least a portion of the second surface of the substrate; a first metallic layer over at least a portion of the first dielectric layer, wherein the first metallic layer is a continuous metallic layer; a first primer layer over at least a portion of the first metallic layer; a second dielectric layer over at least a portion of the first primer layer, wherein the second dielectric layer comprises a first film over at least a portion of the first primer layer and a second film over at least a portion of the first film; a second metallic layer over at least a portion of the second film of the second dielectric layer, wherein the second metallic layer is a discontinuous metallic layer; a second primer layer over at least a portion of the second metallic layer; a third dielectric layer over at least a portion of the second primer layer; a third metallic layer over at least a portion of the third dielectric layer, wherein the third metallic layer is a continuous metallic layer; a third primer layer over at least a portion of the third metallic layer; a fourth dielectric layer over at least a portion of the third primer layer; and a protective layer over at least a portion of the fourth dielectric layer; wherein the coated article comprises: an exterior reflectance b* (Rg b*) of 12>Rg b*>6; an interior reflectance of less than or equal to 16%; and a visible light transmittance of at least 40%.

Clause 2: The coated article of clause 1, wherein the first dielectric layer comprises a first film over at least a portion of the second surface of the substrate and a second film over at least a portion of the first film.

Clause 3: The coated article of clause 2, wherein the first film comprises zinc stannate or tin oxide and the second film comprises zinc oxide.

Clause 4: The coated article of clause 2 or 3, wherein the first film comprises a thickness in the range of from 20 nanometers (“nm”) to 36 nm, such as from 22 nm to 34 nm, such as from 24 nm to 31 nm, or such as from 25 nm to 31.5 nm.

Clause 5: The coated article of clause 2 or 3, wherein the second film comprises a thickness in the range of from 4 nm to 14 nm, such as from 6 nm to 12 nm, such as from 7 nm to 10 nm, or such as from 7.5 nm to 9 nm.

Clause 6: The coated article of any one of clauses 1 to 5, wherein the first dielectric layer comprises a thickness in the range of from 24 nm to 50 nm, such as from 28 nm to 46 nm, such as from 31 nm to 41 nm, or such as from 32.5 nm to 40.5 nm.

Clause 7: The coated article of clause 2 or 3, wherein the first film comprises a thickness in the range of from 15 nm to 30 nm, such as from 17 nm to 28 nm, such as from 18 nm to 25 nm, or such as from 19 nm to 23 nm.

Clause 8: The coated article of clause 2 or 3, wherein the second film comprises a thickness in the range of from 3 nm to 16 nm, such as from 4 nm to 14 nm, such as from 5 nm to 12 nm, or such as from 6 nm to 10 nm.

Clause 9: The coated article of clause 1 to 3, 7, and 8, wherein the first dielectric layer comprises a thickness in the range of from 18 nm to 46 nm, such as from 21 nm to 42 nm, such as from 23 nm to 37 nm, or such as from 25 nm to 33 nm.

Clause 10: The coated article of any one of clauses 1 to 9, wherein the first metallic layer comprises at least one of silver copper, gold, aluminum, mixtures thereof, or alloys thereof.

Clause 11: The coated article of any one of clauses 1 to 10, wherein the first metallic layer comprises silver.

Clause 12: The coated article of any one of clauses 1 to 6, 10, and 11, wherein the first metallic layer comprises a thickness in the range of from 15 nm to 25 nm, such as from 16 nm to 22 nm, such as from 17 nm to 23 nm, or such as from 18.5 nm to 22 nm.

Clause 13: The coated article of any one of clauses 1 to 3 and 7 to 11, wherein the first metallic layer comprises a thickness in the range of from 10 nm to 26 nm, such as from 12 nm to 24 nm, such as from 14 nm to 22 nm, or such as from 16 nm to 20 nm.

Clause 14: The coated article of any one of clauses 1 to 13, wherein the first primer layer is selected from titanium, cobalt, silicon, zinc, aluminum, vanadium, tungsten, tantalum, niobium, zirconium, manganese, chromium, tin, nickel, gallium, indium, germanium, magnesium, molybdenum, silver, silicon carbide, aluminum-doped silver aluminum zinc, vanadium zinc, tungsten tantalum, titanium niobium, zirconium niobium, tungsten niobium, aluminum niobium, aluminum titanium, tungsten titanium, tantalum titanium, zinc titanium, aluminum silver, zinc tin, indium zinc, silver zinc, mixtures thereof, and alloys thereof, and wherein the first primer layer is deposited as a metal and may be subsequently oxidized.

Clause 15: The coated article of any one of clauses 1 to 14, wherein the first primer layer comprises titanium.

Clause 16: The coated article of any one of clauses 1 to 15, wherein the first primer layer comprises a thickness in the range of from 1 nm to 5 nm, such as from 1.5 nm to 4.5 nm, such as from 2 nm to 4 nm, such as from 2.5 nm to 3.5 nm.

Clause 17: The coated article of any one of clauses 1 to 16, wherein the first film of the second dielectric layer comprises zinc oxide.

Clause 18: The coated article of any one of clauses 1 to 17, wherein the first film of the second dielectric layer comprises a thickness in the range of from 3 nm to 11 nm, such as from 5 nm to 10 nm, such as from 6 nm to 9 nm, or such as from 6.5 nm to 8 nm.

Clause 19: The coated article of any one of clauses 1 to 16, wherein the second film of the second dielectric layer comprises zinc stannate.

Clause 20: The coated article of any one of clauses 1 to 6, 10 to 12, 14 to 16, and 19, wherein the second film of the second dielectric layer comprises a thickness in the range of from 2 nm to 12 nm, such as from 3 nm to 11 nm, such as from 4 nm to 10 nm, or such as from 4.5 nm to 9 nm.

Clause 21: The coated article of any one of clauses 1 to 6, 10 to 12, and 14 to 20, wherein the second dielectric layer comprises a thickness in the range of from 5 nm to 23 nm, such as from 8 nm to 21 nm, such as from 10 nm to 19 nm, or such as from 11 nm to 17 nm.

Clause 22: The coated article of any one of clauses 1 to 3, 7 to 11, 13 to 16, and 19, wherein the second film of the second dielectric layer comprises a thickness in the range of from 20 nm to 36 nm, such as from 22 nm to 34 nm, such as from 24 nm to 32 nm, or such as from 26 nm to 30 nm.

Clause 23: The coated article of any one of clauses 1 to 3, 7 to 11, 13 to 19, and 22, wherein the second dielectric layer comprises a thickness in the range of from 23 nm to 47 nm, such as from 27 nm to 44 nm, such as from 30 nm to 41 nm, or such as from 32.5 nm to 38 nm.

Clause 24: The coated article of any one of clauses 1 to 23, wherein the second metallic layer comprises at least one of silver copper, gold, aluminum, mixtures thereof, or alloys thereof.

Clause 25: The coated article of any one of clauses 1 to 24, wherein the second metallic layer comprises silver.

Clause 26: The coated article of any one of clauses 1 to 6, 10 to 12, 14 to 21, 24, and 25, wherein the second metallic layer comprises a thickness in the range of from 0.2 nm to 5 nm, such as from 0.5 nm to 4 nm, such as from 1 nm to 3 nm, or such as from 1.5 nm to 2.5 nm.

Clause 27: The coated article of any one of clauses 1 to 3, 7 to 11, 13 to 19, and 22 to 25, wherein the second metallic layer comprises a thickness in the range of from 0.2 nm to 5 nm, such as from 0.3 nm to 4 nm, such as from 0.4 nm to 3 nm, or such as from 0.5 nm to 2 nm.

Clause 28: The coated article of any one of clauses 1 to 27, wherein the second primer layer is selected from titanium, cobalt, silicon, zinc, aluminum, vanadium, tungsten, tantalum, niobium, zirconium, manganese, chromium, tin, nickel, gallium, indium, germanium, magnesium, molybdenum, silver, silicon carbide, aluminum-doped silver aluminum zinc, vanadium zinc, tungsten tantalum, titanium niobium, zirconium niobium, tungsten niobium, aluminum niobium, aluminum titanium, tungsten titanium, tantalum titanium, zinc titanium, aluminum silver, zinc tin, indium zinc, silver zinc, mixtures thereof, and alloys thereof, and wherein the second primer layer is deposited as a metal and may be subsequently oxidized.

Clause 29: The coated article of any one of clauses 1 to 28, wherein the second primer layer comprises titanium.

Clause 30: The coated article of any one of clauses 1 to 6, 10 to 12, 14 to 21, 24 to 26, 28, and 29, wherein the second primer layer comprises a thickness in the range of from 0.2 nm to 4 nm, such as from 0.5 nm to 3.5 nm, such as from 0.7 nm to 3 nm, or such as from 1 nm to 2.5 nm.

Clause 31: The coated article of any one of clauses 1 to 3, 7 to 11, 13 to 19, 22 to 25, 28, and 29, wherein the second primer layer comprises a thickness in the range of 0.5 nm to 6 nm, such as from 1 nm to 5.5 nm, such as from 2 nm to 5 nm, or such as from 2.5 nm to 4.5 nm.

Clause 32: The coated article of any one of clauses 1 to 31, wherein the second primer layer is thinner than the first primer layer.

Clause 33: The coated article of any one of clauses 1 to 6, 10 to 12, 14 to 21, 24 to 26, 28 to 30, and 32, wherein the third dielectric layer comprises a first film over at least a portion of second primer layer and a second film over at least a portion of the first film.

Clause 34: The coated article of cause 33, wherein the first film of the third dielectric layer comprises zinc stannate.

Clause 35: The coated article of clause 33 or 34, wherein the first film of the third dielectric layer comprises a thickness in the range of from 45 nm to 57 nm, such as from 48 nm to 55 nm, such as from 50 nm to 54 nm, or such as from 51 nm to 53 nm.

Clause 36: The coated article of clause 33, wherein the second film of the third dielectric layer comprises zinc oxide.

Clause 37: The coated article of clause 33 or 36, wherein the second film of the third dielectric layer comprises a thickness in the range of from 4 nm to 11 nm, such as from 5 nm to 10 nm, such as from 5.5 nm to 9 nm, or such as from 6 nm to 8.5 nm.

Clause 38: The coated article of any one of clauses 33 to 37, wherein the third dielectric layer comprises a thickness in the range of from 49 nm to 68 nm, such as from 53 nm to 65 nm, such as from 55.5 nm to 63 nm, or such as from 57 nm to 61.5 nm.

Clause 39: The coated article of any one of clauses 1 to 3, 7 to 11, 13 to 19, 22 to 25, 28, 29, 31, and 32, wherein the third dielectric layer comprises a first film over at least a portion of second primer layer, a second film over at least a portion of the first film, and a third film over at least a portion of the second film.

Clause 40: The coated article of clause 39, wherein the first film of the third dielectric layer comprises zinc oxide.

Clause 41: The coated article of clause 39 or 40, wherein the first film of the third dielectric layer comprises a thickness in the range of from 3 nm to 16 nm, such as from 4 nm to 14 nm, such as from 5 nm to 12 nm, or such as from 6 nm to 10 nm.

Clause 42: The coated article of clause 39, wherein the second film of the third dielectric layer comprises zinc stannate.

Clause 43: The coated article of clause 39 or 42, wherein the second film of the third dielectric layer comprises a thickness in the range of from 28 nm to 42 nm, such as from 30 nm to 40 nm, such as from 32 nm to 38 nm, or such as from 34 nm to 36 nm.

Clause 44: The coated article of clause 39, wherein the third film of the third dielectric layer comprises a zinc oxide.

Clause 45: The coated article of clause 39 or 44, wherein the third film of the third dielectric layer comprises a thickness in the range of from 3 nm to 16 nm, such as from 4 nm to 14 nm, such as from 5 nm to 12 nm, or such as from 6 nm to 10 nm.

Clause 46: The coated article of any one of clauses 39 to 45, wherein the third dielectric layer comprises a thickness in the range of from 34 nm to 74 nm, such as from 38 nm to 68 nm, such as from 42 nm to 62 nm, or such as from 46 nm to 56 nm.

Clause 47: The coated article of any one of clauses 1 to 46, wherein the third metallic layer comprises a thickness in the range of from 9 nm to 16 nm, such as from 10 nm to 15 nm, such as from 11 nm to 14.5 nm, or such as from 11.5 nm to 14 nm.

Clause 48: The coated article of any one of clauses 1 to 47, wherein the third metallic layer comprises at least one of silver copper, gold, aluminum, mixtures thereof, or alloys thereof.

Clause 49: The coated article of any one of clauses 1 to 48, wherein the third metallic layer comprises silver.

Clause 50: The coated article of any one of clauses 1 to 49, wherein the third primer layer is selected from titanium, cobalt, silicon, zinc, aluminum, vanadium, tungsten, tantalum, niobium, zirconium, manganese, chromium, tin, nickel, gallium, indium, germanium, magnesium, molybdenum, silver, silicon carbide, aluminum-doped silver aluminum zinc, vanadium zinc, tungsten tantalum, titanium niobium, zirconium niobium, tungsten niobium, aluminum niobium, aluminum titanium, tungsten titanium, tantalum titanium, zinc titanium, aluminum silver, zinc tin, indium zinc, silver zinc, mixtures thereof, and alloys thereof, and wherein the third primer layer is deposited as a metal and may be subsequently oxidized.

Clause 51: The coated article of any one of clauses 1 to 50, wherein the third primer layer comprises titanium.

Clause 52: The coated article of any one of clauses 1 to 51, wherein the third primer layer comprises a thickness in the range of from 1 nm to 5 nm, such as from 1.5 nm to 4.5 nm, such as from 2 nm to 4 nm, or such as from 2.5 nm to 3.5 nm.

Clause 53: The coated article of any one of clauses 1 to 52, wherein the third primer layer is thicker than the second primer layer.

Clause 54: The coated article of any one of clauses 1 to 53, wherein the fourth dielectric layer comprises a first film over at least a portion of the third primer layer and a second film over at least a portion of the first film.

Clause 55: The coated article of clause 54, wherein the first film of the fourth dielectric layer comprises zinc oxide.

Clause 56: The coated article of clause 54 or 55, wherein the first film of the fourth dielectric layer comprises a thickness in the range of from 4 nm to 14 nm, such as from 6 nm to 12 nm, such as from 7 nm to 10 nm, or such as from 7.5 nm to 9 nm.

Clause 57: The coated article of clause 54, wherein the second film of the fourth dielectric layer comprises zinc stannate.

Clause 58: The coated article of clause 54 or 57, wherein the second film of the fourth dielectric layer comprises a thickness in the range of from 12 nm to 24 nm, such as from 14 nm to 22 nm, such as from 12 nm to 16 nm, or such as from 19 nm to 21 nm.

Clause 59: The coated article of any one of clauses 1 to 58, wherein the fourth dielectric layer comprises a thickness in the range of from 16 nm to 38 nm, such as from 20 nm to 34 nm, such as from 19 nm to 26 nm, or such as from 26.5 nm to 30 nm.

Clause 60: The coated article of any one of clauses 1 to 59, wherein the protective layer is the outermost layer of the functional coating.

Clause 61: The coated article of any one of clauses 1 to 6, 10 to 12, 14 to 21, 24 to 26, 28 to 30, 32 to 38, and 47 to 60, wherein the protective layer comprises a thickness in the range of from 1 nm to 6 nm, such as from 2 nm to 5 nm, or such as from 3 nm to 4 nm.

Clause 62: The coated article of any one of clauses 1 to 3, 7 to 11, 13 to 19, 22 to 25, 28, 29, 31, 32, and 39 to 60, wherein the protective layer comprises a thickness in the range of 1 nm to 7 nm, such as from 2 nm to 6 nm, or such as from 3 nm to 5 nm.

Clause 63: The coated article of any one of clauses 1 to 62, wherein the Rg b* is 11.5>Rg b*>6, such as 11>Rg b*>6, such as 11.5>Rg b*>9, such as, or such as 10>Rgb*>7.

Clause 64: The coated article of any one of clauses 1 to 63, wherein the coated article comprises an exterior reflectance a* (Rg a*) of −2.5<Rg a*<2.5, or such as −2<Rg a*<2.

Clause 65: The coated article of clause 64, wherein the Rg a* is-1<Rg a*<1.

Clause 66: The coated article of any one of clauses 1 to 65, wherein the coated article comprises an exterior reflectance in a range from 20% to 40%.

Clause 67: The coated article of any one of clauses 1 to 3, 7 to 11, 13 to 19, 22 to 25, 28, 29, 31, 32, 39 to 60, and 62 to 66, wherein the coated article comprises an exterior reflectance of not greater than 26%.

Clause 68: The coated article of any one of clauses 1 to 6, 10 to 12, 14 to 21, 24 to 26, 28 to 30, 32 to 38, 47 to 61, and 63 to 66, wherein the coated article comprises an exterior reflectance of at least 30%.

Clause 69: The coated article of any one of clauses 1 to 6, 10 to 12, 14 to 21, 24 to 26, 28 to 30, 32 to 38, 47 to 61, and 63 to 66, wherein the coated article comprises an exterior reflectance of at least 35%.

Clause 70: The coated article of any one of clauses 1 to 69, wherein the visible light transmittance is in a range of from 40% to 50%.

Clause 71: The coated article of any one of clauses 1 to 70, wherein the interior reflectance is in a range of from 8% to 16%.

Clause 72: The coated article of any one of clauses 1 to 71, wherein the substrate comprises glass.

Clause 73: A coated transparency comprising: a first substrate comprising a No. 1 surface and a No. 2 surface opposite the No. 1 surface; a second substrate comprising a No. 3 surface and No. 4 surface opposite the No. 3 surface, wherein the second substrate is spaced apart from the first substrate, wherein the No. 3 surface faces the No. 2 surface, and wherein the first substrate and the second substrate are connected together; and a functional coating over at least a portion of the No. 2 surface of the first substrate or the No. 3 surface of the second substrate, the functional coating comprising: a first dielectric layer over at least a portion of the No. 2 surface of the first substrate or the No. 3 surface of the second substrate; a first metallic layer over at least a portion of the first dielectric layer, wherein the first metallic layer is a continuous metallic layer; a first primer layer over at least a portion of the first metallic layer; a second dielectric layer over at least a portion of the first primer layer, wherein the second dielectric layer comprises a first film over at least a portion of the first primer layer and a second film over at least a portion of the first film; a second metallic layer over at least a portion of the second film of the second dielectric layer, wherein the second metallic layer is a discontinuous metallic layer; a second primer layer over at least a portion of the second metallic layer; a third dielectric layer over at least a portion of the second primer layer; a third metallic layer over at least a portion of the third dielectric layer, wherein the third metallic layer is a continuous metallic layer; a third primer layer over at least a portion of the third metallic layer; a fourth dielectric layer over at least a portion of the third primer layer; and a protective layer over at least a portion of the fourth dielectric layer; wherein the coated transparency comprises: an exterior reflectance b* (Rg b*) of 12>Rg b*>6; an interior reflectance of less than or equal to 16%; and a visible light transmittance of at least 40%.

Clause 74: The coated transparency of clause 73, wherein the first dielectric layer comprises a first film over at least a portion of the No. 2 surface of the first substrate or the No. 3 surface of the second substrate and a second film over at least a portion of the first film.

Clause 75: The coated transparency of claim 74, wherein the first film comprises zinc stannate or tin oxide and the second film comprises zinc oxide.

Clause 76: The coated transparency of clause 74 or 75, wherein the first film comprises a thickness in the range of from 20 nm to 36 nm, such as from 22 nm to 34 nm, such as from 24 nm to 31 nm, or such as from 25 nm to 31.5 nm.

Clause 77: The coated transparency of clause 74 or 75, wherein the second film comprises a thickness in the range of from 4 nm to 14 nm, such as from 6 nm to 12 nm, such as from 7 nm to 10 nm, or such as from 7.5 nm to 9 nm.

Clause 78: The coated transparency of any one of clauses 73 to 77, wherein the first dielectric layer comprises a thickness in the range of from 24 nm to 50 nm, such as from 28 nm to 46 nm, such as from 31 nm to 41 nm, or such as from 32.5 nm to 40.5 nm.

Clause 79: The coated transparency of clause 74 or 75, wherein the first film comprises a thickness in the range of from 15 nm to 30 nm, such as from 17 nm to 28 nm, such as from 18 nm to 25 nm, or such as from 19 nm to 23 nm.

Clause 80: The coated transparency of clause 74 or 75, wherein the second film comprises a thickness in the range of from 3 nm to 16 nm, such as from 4 nm to 14 nm, such as from 5 nm to 12 nm, or such as from 6 nm to 10 nm.

Clause 81: The coated transparency of clause 73 to 75, 79, and 80, wherein the first dielectric layer comprises a thickness in the range of from 18 nm to 46 nm, such as from 21 nm to 42 nm, such as from 23 nm to 37 nm, or such as from 25 nm to 33 nm.

Clause 82: The coated transparency of any one of clauses 73 to 81, wherein the first metallic layer comprises at least one of silver copper, gold, aluminum, mixtures thereof, or alloys thereof.

Clause 83: The coated transparency of any one of clauses 73 to 82, wherein the first metallic layer comprises silver.

Clause 84: The coated transparency of any one of clauses 73 to 78, 82, and 83, wherein the first metallic layer comprises a thickness in the range of from 15 nm to 25 nm, such as from 16 nm to 22 nm, such as from 17 nm to 23 nm, or such as from 18.5 nm to 22 nm.

Clause 85: The coated transparency of any one of clauses 73 to 75 and 79 to 83, wherein the first metallic layer comprises a thickness in the range of from 10 nm to 26 nm, such as from 12 nm to 24 nm, such as from 14 nm to 22 nm, or such as from 16 nm to 20 nm.

Clause 86: The coated transparency of any one of clauses 73 to 85, wherein the first primer layer is selected from titanium, cobalt, silicon, zinc, aluminum, vanadium, tungsten, tantalum, niobium, zirconium, manganese, chromium, tin, nickel, gallium, indium, germanium, magnesium, molybdenum, silver, silicon carbide, aluminum-doped silver aluminum zinc, vanadium zinc, tungsten tantalum, titanium niobium, zirconium niobium, tungsten niobium, aluminum niobium, aluminum titanium, tungsten titanium, tantalum titanium, zinc titanium, aluminum silver, zinc tin, indium zinc, silver zinc, mixtures thereof, and alloys thereof, and wherein the first primer layer is deposited as a metal and may be subsequently oxidized.

Clause 87: The coated transparency of any one of clauses 73 to 86, wherein the first primer layer comprises titanium.

Clause 88: The coated transparency of any one of clauses 73 to 87, wherein the first primer layer comprises a thickness in the range of from 1 nm to 5 nm, such as from 1.5 nm to 4.5 nm, such as from 2 nm to 4 nm, or such as from 2.5 nm to 3.5 nm.

Clause 89: The coated transparency of any one of clauses 73 to 88, wherein the first film of the second dielectric layer comprises zinc oxide.

Clause 90: The coated transparency of any one of clauses 73 to 89, wherein the first film of the second dielectric layer comprises a thickness in the range of from 3 nm to 11 nm, such as from 5 nm to 10 nm, such as from 6 nm to 9 nm, or such as from 6.5 nm to 8 nm.

Clause 91: The coated transparency of any one of clauses 73 to 90, wherein the second film of the second dielectric layer comprises zinc stannate.

Clause 92: The coated transparency of any one of clauses 73 to 78, 82 to 84, and 86 to 88, and 91, wherein the second film of the second dielectric layer comprises a thickness in the range of from 2 nm to 12 nm, such as from 3 nm to 11 nm, such as from 4 nm to 10 nm, or such as from 4.5 nm to 9 nm.

Clause 93: The coated transparency of any one of clauses 73 to 78, 82 to 84, and 86 to 92, wherein the second dielectric layer comprises a thickness in the range of from 5 nm to 23 nm, such as from 8 nm to 21 nm, such as from 10 nm to 19 nm, or such as from 11 nm to 17 nm.

Clause 94: The coated transparency of any one of clauses 73 to 75, 79 to 83, and 85 to 89, and 91, wherein the second film of the second dielectric layer comprises a thickness in the range of from 20 nm to 36 nm, such as from 22 nm to 34 nm, such as from 24 nm to 32 nm, or such as from 26 nm to 30 nm.

Clause 95: The coated transparency of any one of clauses 73 to 75, 79 to 83, 85 to 91, and 94, wherein the second dielectric layer comprises a thickness in the range of from 23 nm to 47 nm, such as from 27 nm to 44 nm, such as from 30 nm to 41 nm, or such as from 32.5 nm to 38 nm.

Clause 96: The coated transparency of any one of clauses 73 to 95, wherein the second metallic layer comprises at least one of silver copper, gold, aluminum, mixtures thereof, or alloys thereof.

Clause 97: The coated transparency of any one of clauses 73 to 96, wherein the second metallic layer comprises silver.

Clause 98: The coated transparency of any one of clauses 73 to 78, 82 to 85, 86 to 93, 96, and 97, wherein the second metallic layer comprises a thickness in the range of from 0.2 nm to 5 nm, such as from 0.5 nm to 4 nm, such as from 1 nm to 3 nm, or such as from 1.5 nm to 2.5 nm.

Clause 99: The coated transparency of any one of clauses 73 to 75, 79 to 83, 85 to 91, and 94 to 97, wherein the second metallic layer comprises a thickness in the range of from 0.2 nm to 5 nm, such as from 0.3 nm to 4 nm, such as from 0.4 nm to 3 nm, or such as from 0.5 nm to 2 nm

Clause 100: The coated transparency of any one of clauses 73 to 99, wherein the second primer layer is selected from titanium, cobalt, silicon, zinc, aluminum, vanadium, tungsten, tantalum, niobium, zirconium, manganese, chromium, tin, nickel, gallium, indium, germanium, magnesium, molybdenum, silver, silicon carbide, aluminum-doped silver aluminum zinc, vanadium zinc, tungsten tantalum, titanium niobium, zirconium niobium, tungsten niobium, aluminum niobium, aluminum titanium, tungsten titanium, tantalum titanium, zinc titanium, aluminum silver, zinc tin, indium zinc, silver zinc, mixtures thereof, and alloys thereof, and wherein the second primer layer is deposited as a metal and may be subsequently oxidized.

Clause 101: The coated transparency of any one of clauses 73 to 100, wherein the second primer layer comprises titanium.

Clause 102: The coated transparency of any one of clauses 73 to 78, 82 to 84, 86 to 93, 96 to 98, 100, and 101, wherein the second primer layer comprises a thickness in the range of from 0.2 nm to 4 nm, such as from 0.5 nm to 3.5 nm, such as from 0.7 nm to 3 nm, or such as from 1 nm to 2.5 nm.

Clause 103: The coated transparency of any one of clauses 73 to 75, 79 to 83, 85 to 91, 94 to 97, and 99 to 101, wherein the second primer layer comprises a thickness in the range of 0.5 nm to 6 nm, such as from 1 nm to 5.5 nm, such as from 2 nm to 5 nm, or such as from 2.5 nm to 4.5 nm.

Cause 104: The coated transparency of any one of clauses 73 to 103, wherein the second primer layer is thinner than the first primer layer.

Clause 105: The coated transparency of any one of clauses 73 to 87, 82 to 84, 86 to 93, 96 to 98, 100 to 102, and 104, wherein the third dielectric layer comprises a first film over at least a portion of second primer layer and a second film over at least a portion of the first film.

Clause 106: The coated transparency of clause 105, wherein the first film of the third dielectric layer comprises zinc stannate.

Clause 107: The coated transparency of clause 105 or 106, wherein the first film of the third dielectric layer comprises a thickness in the range of from 45 nm to 57 nm, such as from 48 nm to 55 nm, such as from 50 nm to 54 nm, or such as from 51 nm to 53 nm.

Clause 108: The coated transparency of clause 105, wherein the second film of the third dielectric layer comprises zinc oxide.

Clause 109: The coated transparency of clause 105 or 108, wherein the second film of the third dielectric layer comprises a thickness in the range of from 4 nm to 11 nm, such as from 5 nm to 10 nm, such as from 5.5 nm to 9 nm, or such as from 6 nm to 8.5 nm.

Clause 110: The coated transparency of any one of clauses 105 to 109, wherein the third dielectric layer comprises a thickness in the range of from 49 nm to 68 nm, such as from 53 nm to 65 nm, such as from 55.5 nm to 63 nm, or such as from 57 nm to 61.5 nm.

Clause 111: The coated transparency of any one of clauses 73 to 75, 79 to 83, 85 to 91, 94 to 97, 99 to 101, 103, and 104, wherein the third dielectric layer comprises a first film over at least a portion of second primer layer, a second film over at least a portion of the first film, and a third film over at least a portion of the second film.

Clause 112: The coated transparency of clause 111, wherein the first film of the third dielectric layer comprises zinc oxide.

Clause 113: The coated transparency of clause 111 or 112, wherein the first film of the third dielectric layer comprises a thickness in the range of from 3 nm to 16 nm, such as from 4 nm to 14 nm, such as from 5 nm to 12 nm, or such as from 6 nm to 10 nm.

Clause 114: The coated article of clause 111, wherein the second film of the third dielectric layer comprises zinc stannate.

Clause 115: The coated transparency of clause 111 or 114, wherein the second film of the third dielectric layer comprises a thickness in the range of from 28 nm to 42 nm, such as from 30 nm to 40 nm, such as from 32 nm to 38 nm, or such as from 34 nm to 36 nm.

Clause 116: The coated transparency of clause 111, wherein the third film of the third dielectric layer comprises a zinc oxide.

Clause 117: The coated transparency of clause 111 or 116, wherein the third film of the third dielectric layer comprises a thickness in the range of from 3 nm to 16 nm, such as from 4 nm to 14 nm, such as from 5 nm to 12 nm, or such as from 6 nm to 10 nm.

Clause 118: The coated transparency of any one of clauses 111 to 117, wherein the third dielectric layer comprises a thickness in the range of from 34 nm to 74 nm, such as from 38 nm to 68 nm, such as from 42 nm to 62 nm, or such as from 46 nm to 56 nm.

Clause 119: The coated transparency of any one of clauses 73 to 118, wherein the third metallic layer comprises a thickness in the range of from 9 nm to 16 nm, such as from 10 nm to 15 nm, such as from 11 nm to 14.5 nm, or such as from 11.5 nm to 14 nm.

Clause 120: The coated transparency of any one of clauses 73 to 119, wherein the third metallic layer comprises at least one of silver copper, gold, aluminum, mixtures thereof, or alloys thereof.

Clause 121: The coated transparency of any one of clauses 73 to 120, wherein the third metallic layer comprises silver.

Clause 122: The coated transparency of any one of clauses 73 to 121, wherein the third primer layer is selected from titanium, cobalt, silicon, zinc, aluminum, vanadium, tungsten, tantalum, niobium, zirconium, manganese, chromium, tin, nickel, gallium, indium, germanium, magnesium, molybdenum, silver, silicon carbide, aluminum-doped silver aluminum zinc, vanadium zinc, tungsten tantalum, titanium niobium, zirconium niobium, tungsten niobium, aluminum niobium, aluminum titanium, tungsten titanium, tantalum titanium, zinc titanium, aluminum silver, zinc tin, indium zinc, silver zinc, mixtures thereof, and alloys thereof, and wherein the third primer layer is deposited as a metal and may be subsequently oxidized.

Clause 123: The coated transparency of any one of clauses 73 to 122, wherein the third primer layer comprises titanium.

Clause 124: The coated transparency of any one of clauses 73 to 123, wherein the third primer layer comprises a thickness in the range of from 1 nm to 5 nm, such as from 1.5 nm to 4.5 nm, such as from 2 nm to 4 nm, or such as from 2.5 nm to 3.5 nm.

Clause 125: The coated transparency of any one of clauses 73 to 124, wherein the third primer layer is thicker than the second primer layer.

Clause 126: The coated transparency of any one of clauses 73 to 125, wherein the fourth dielectric layer comprises a first film over at least a portion of the third primer layer and a second film over at least a portion of the first film.

Clause 127: The coated transparency of clause 126, wherein the first film of the fourth dielectric layer comprises zinc oxide.

Clause 128: The coated transparency of clause 126 or 127, wherein the first film of the fourth dielectric layer comprises a thickness in the range of from 4 nm to 14 nm, such as from 6 nm to 12 nm, such as from 7 nm to 10 nm, or such as from 7.5 nm to 9 nm.

Clause 129: The coated transparency of clause 126, wherein the second film of the fourth dielectric layer comprises zinc stannate.

Clause 130: The coated transparency of clause 126 or 129, wherein the second film of the fourth dielectric layer comprises a thickness in the range of from 12 nm to 24 nm, such as from 14 nm to 22 nm, such as from 12 nm to 16 nm, or such as from 19 nm to 21 nm.

Clause 131: The coated transparency of any one of clauses 73 to 130, wherein the fourth dielectric layer comprises a thickness in the range of from 16 nm to 38 nm, such as from 20 nm to 34 nm, such as from 19 nm to 26 nm, or such as from 26.5 nm to 30 nm.

Clause 132: The coated transparency of any one of clauses 73 to 131, wherein the protective layer is the outermost layer of the functional coating.

Clause 133: The coated transparency of any one of clauses 73 to 78, 82 to 84, 86 to 93, 96 to 98, 100 to 102, 104 to 110, and 119 to 132, wherein the protective layer comprises a thickness in the range of from 1 nm to 6 nm, such as from 2 nm to 5 nm, or such as from 3 nm to 4 nm.

Clause 134: The coated transparency of any one of clauses 73 to 75, 79 to 83, 85 to 91, 94 to 97, 99 to 101, 103, 104, and 111 to 132, wherein the protective layer comprises a thickness in the range of from 1 nm to 7 nm, such as from 2 nm to 6 nm, or such as from 3 nm to 5 nm

Clause 135: The coated transparency of any one of clauses 73 to 134, wherein the Rg b* is 11.5>Rg b*>6, such as 11>Rgb*>6, such as 11.5>Rg b*>9, such as, or such as 10>Rgb*>7.

Clause 136: The coated transparency of any one of clauses 73 to 135, wherein the coated transparency comprises an exterior reflectance a* (Rg a*) of −2.5<Rg a*<2.5, or such as −2<Rg a*<2.

Clause 137: The coated transparency of clause 136, wherein the Rg a* is −1<Rg a*<1.

Clause 138: The coated transparency of any one of clauses 73 to 137, wherein the coated article comprises an exterior reflectance in a range from 20% to 40%.

Clause 139: The coated transparency of any one of clauses 73 to 75, 79 to 83, 85 to 91, 94 to 97, 99 to 101, 103, 104, 111 to 132, and 134 to 138, wherein the coated article comprises an exterior reflectance of not greater than 26%.

Clause 140: The coated transparency of any one of clauses 73 to 78, 82 to 84, 86 to 93, 96 to 98, 100 to 102, 104 to 110, 119 to 133, and 135 to 138, wherein the coated transparency comprises an exterior reflectance of at least 30%.

Clause 141: The coated transparency of any one of clauses 73 to 78, 82 to 84, 86 to 93, 96 to 98, 100 to 102, 104 to 110, 119 to 133, and 135 to 138, wherein the coated transparency comprises an exterior reflectance of at least 35%.

Clause 142: The coated transparency of any one of clauses 73 to 141, wherein the visible light transmittance is in a range of from 40% to 50%.

Clause 143: The coated transparency of any one of clauses 73 to 142, wherein the interior reflectance is in a range of from 8% to 16%.

Clause 144: The coated transparency of any one of clauses 73 to 143, wherein the functional coating is on the No. 2 surface of the first substrate.

Clause 145: The coated transparency of any one of clauses 73 to 144, wherein the first substrate and the second substrate comprises glass.

Clause 146: A method of making a coated article, the method comprising: providing a substrate comprising a first surface and a second surface opposite the first surface; and forming a functional coating over at least a portion of the second surface of the substrate, wherein forming the functional coating comprises: forming a first dielectric layer over at least a portion of the second surface of the substrate; forming a first metallic layer over at least a portion of the first dielectric layer, wherein the first metallic layer is a continuous metallic layer; forming a first primer layer over at least a portion of the first metallic layer; forming a second dielectric layer over at least a portion of the first primer layer, wherein forming the second dielectric layer comprises forming a first film over at least a portion of the first primer layer and forming a second film over at least a portion of the first film; forming a second metallic layer over at least a portion of the second film of the second dielectric layer, wherein the second metallic layer is a discontinuous metallic layer; forming a second primer layer over at least a portion of the second metallic layer; forming a third dielectric layer over at least a portion of the second primer layer; forming a third metallic layer over at least a portion of the third dielectric layer, wherein the third metallic layer is a continuous metallic layer; forming a third primer layer over at least a portion of the third metallic layer; forming a fourth dielectric layer over at least a portion of the third primer layer; and forming a protective layer over at least a portion of the fourth dielectric layer; wherein the coated article comprises: an exterior reflectance b* (Rg b*) of 12>Rg b*>6; an interior reflectance of less than or equal to 16%; and a visible light transmittance of at least 40%.

Clause 147: The method of clause 146, wherein the first dielectric layer comprises a first film over at least a portion of the second surface of the substrate and a second film over at least a portion of the first film.

Clause 148: The method of clause 147, wherein the first film comprises zinc stannate or tin oxide and the second film comprises zinc oxide.

Clause 149: The method of clause 147 or 148, wherein the first film comprises a thickness in the range of from 20 nm to 36 nm, such as from 22 nm to 34 nm, such as from 24 nm to 31 nm, or such as from 25 nm to 31.5 nm.

Clause 150: The method of clause 147 or 148, wherein the second film comprises a thickness in the range of from 4 nm to 14 nm, such as from 6 nm to 12 nm, such as from 7 nm to 10 nm, or such as from 7.5 nm to 9 nm.

Clause 151: The method of any one of clauses 146 to 150, wherein the first dielectric layer comprises a thickness in the range of from 24 nm to 50 nm, such as from 28 nm to 46 nm, such as from 31 nm to 41 nm, or such as from 32.5 nm to 40.5 nm.

Clause 152: The method of clause 147 or 148, wherein the first film comprises a thickness in the range of from 15 nm to 30 nm, such as from 17 nm to 28 nm, such as from 18 nm to 25 nm, or such as from 19 nm to 23 nm.

Clause 153: The method of clause 147 or 148, wherein the second film comprises a thickness in the range of from 3 nm to 16 nm, such as from 4 nm to 14 nm, such as from 5 nm to 12 nm, or such as from 6 nm to 10 nm.

Clause 154: The method of clause 146 to 148, 152, and 153, wherein the first dielectric layer comprises a thickness in the range of from 18 nm to 46 nm, such as from 21 nm to 42 nm, such as from 23 nm to 37 nm, or such as from 25 nm to 33 nm.

Clause 155: The method of any one of clauses 146 to 154, wherein the first metallic layer comprises at least one of silver copper, gold, aluminum, mixtures thereof, or alloys thereof.

Clause 156: The method of any one of clauses 146 to 155, wherein the first metallic layer comprises silver.

Clause 157: The method of any one of clauses 146 to 151, 155, and 156, wherein the first metallic layer comprises a thickness in the range of from 15 nm to 25 nm, such as from 16 nm to 22 nm, such as from 17 nm to 23 nm, or such as from 18.5 nm to 22 nm.

Clause 158: The method of any one of clauses 146 to 148 and 152 to 156, wherein the first metallic layer comprises a thickness in the range of from 10 nm to 26 nm, such as from 12 nm to 24 nm, such as from 14 nm to 22 nm, or such as from 16 nm to 20 nm.

Clause 159: The method of any one of clauses 146 to 158, wherein the first primer layer is selected from titanium, cobalt, silicon, zinc, aluminum, vanadium, tungsten, tantalum, niobium, zirconium, manganese, chromium, tin, nickel, gallium, indium, germanium, magnesium, molybdenum, silver, silicon carbide, aluminum-doped silver aluminum zinc, vanadium zinc, tungsten tantalum, titanium niobium, zirconium niobium, tungsten niobium, aluminum niobium, aluminum titanium, tungsten titanium, tantalum titanium, zinc titanium, aluminum silver, zinc tin, indium zinc, silver zinc, mixtures thereof, and alloys thereof, and wherein the first primer layer is deposited as a metal and may be subsequently oxidized.

Clause 160: The method of any one of clauses 146 to 159, wherein the first primer layer comprises titanium.

Clause 161: The method of any one of clauses 146 to 160, wherein the first primer layer comprises a thickness in the range of from 1 nm to 5 nm, such as from 1.5 nm to 4.5 nm, such as from 2 nm to 4 nm, such as from 2.5 nm to 3.5 nm.

Clause 162: The method of any one of clauses 146 to 161, wherein the first film of the second dielectric layer comprises zinc oxide.

Clause 163: The method of any one of clauses 146 to 162, wherein the first film of the second dielectric layer comprises a thickness in the range of from 3 nm to 11 nm, such as from 5 nm to 10 nm, such as from 6 nm to 9 nm, or such as from 6.5 nm to 8 nm.

Clause 164: The method of any one of clauses 146 to 161, wherein the second film of the second dielectric layer comprises zinc stannate.

Clause 165: The method of any one of clauses 146 to 151, 155 to 157, 159 to 161, and 164, wherein the second film of the second dielectric layer comprises a thickness in the range of from 2 nm to 12 nm, such as from 3 nm to 11 nm, such as from 4 nm to 10 nm, or such as from 4.5 nm to 9 nm.

Clause 166: The method of any one of clauses 146 to 151, 155 to 157, and 159 to 165, wherein the second dielectric layer comprises a thickness in the range of from 5 nm to 23 nm, such as from 8 nm to 21 nm, such as from 10 nm to 19 nm, or such as from 11 nm to 17 nm.

Clause 167: The method of any one of clauses 146 to 148, 152 to 156, 159 to 161, and 164, wherein the second film of the second dielectric layer comprises a thickness in the range of from 20 nm to 36 nm, such as from 22 nm to 34 nm, such as from 24 nm to 32 nm, or such as from 26 nm to 30 nm.

Clause 168: The method of any one of clauses 146 to 148, 152 to 156, 159 to 161, 164, and 166, wherein the second dielectric layer comprises a thickness in the range of from 23 nm to 47 nm, such as from 27 nm to 44 nm, such as from 30 nm to 41 nm, or such as from 32.5 nm to 38 nm.

Clause 169: The method of any one of clauses 146 to 168, wherein the second metallic layer comprises at least one of silver copper, gold, aluminum, mixtures thereof, or alloys thereof.

Clause 170: The method of any one of clauses 146 to 169, wherein the second metallic layer comprises silver.

Clause 171: The method of any one of clauses 146 to 151, 155 to 157, 159 to 166, 169 and 170, wherein the second metallic layer comprises a thickness in the range of from 0.2 nm to 5 nm, such as from 0.5 nm to 4 nm, such as from 1 nm to 3 nm, or such as from 1.5 nm to 2.5 nm.

Clause 172: The method of any one of clauses 146 to 148, 152 to 156, 159 to 162, 164, and 167 to 170, wherein the second metallic layer comprises a thickness in the range of from 0.2 nm to 5 nm, such as from 0.3 nm to 4 nm, such as from 0.4 nm to 3 nm, or such as from 0.5 nm to 2 nm

Clause 173: The method of any one of clauses 146 to 172, wherein the second primer layer is selected from titanium, cobalt, silicon, zinc, aluminum, vanadium, tungsten, tantalum, niobium, zirconium, manganese, chromium, tin, nickel, gallium, indium, germanium, magnesium, molybdenum, silver, silicon carbide, aluminum-doped silver aluminum zinc, vanadium zinc, tungsten tantalum, titanium niobium, zirconium niobium, tungsten niobium, aluminum niobium, aluminum titanium, tungsten titanium, tantalum titanium, zinc titanium, aluminum silver, zinc tin, indium zinc, silver zinc, mixtures thereof, and alloys thereof, and wherein the second primer layer is deposited as a metal and may be subsequently oxidized.

Clause 174: The method of any one of clauses 146 to 173, wherein the second primer layer comprises titanium.

Clause 175: The method of any one of clauses 146 to 151, 155 to 157, 159 to 166, 169 to 171, 173, and 174, wherein the second primer layer comprises a thickness in the range of from 0.2 nm to 4 nm, such as from 0.5 nm to 3.5 nm, such as from 0.7 nm to 3 nm, or such as from 1 nm to 2.5 nm.

Clause 176: The method of any one of clauses 146 to 148, 152 to 156, 159 to 162, 164, 167 to 170, and 172 to 174, wherein the second primer layer comprises a thickness in the range of 0.5 nm to 6 nm, such as from 1 nm to 5.5 nm, such as from 2 nm to 5 nm, or such as from 2.5 nm to 4.5 nm.

Clause 177: The method of any one of clauses 146 to 176, wherein the second primer layer is thinner than the first primer layer.

Clause 178: The method of any one of clauses 146 to 151, 155 to 157, 159 to 166, 169 to 171, 173 to 175, and 177, wherein the third dielectric layer comprises a first film over at least a portion of second primer layer and a second film over at least a portion of the first film.

Clause 179: The method of clause 178, wherein the first film of the third dielectric layer comprises zinc stannate.

Clause 180: The method of clause 178 or 179, wherein the first film of the third dielectric layer comprises a thickness in the range of from 45 nm to 57 nm, such as from 48 nm to 55 nm, such as from 50 nm to 54 nm, or such as from 51 nm to 53 nm.

Clause 181: The method of clause 178, wherein the second film of the third dielectric layer comprises zinc oxide.

Clause 182: The method of clause 178 or 181, wherein the second film of the third dielectric layer comprises a thickness in the range of from 4 nm to 11 nm, such as from 5 nm to 10 nm, such as from 5.5 nm to 9 nm, or such as from 6 nm to 8.5 nm.

Clause 183: The method of any one of clauses 178 to 182, wherein the third dielectric layer comprises a thickness in the range of from 49 nm to 68 nm, such as from 53 nm to 65 nm, such as from 55.5 nm to 63 nm, or such as from 57 nm to 61.5 nm.

Clause 184: The method of any one of clauses 146 to 148, 152 to 156, 159 to 162, 164, 167 to 170, 172 to 174, and 177, wherein the third dielectric layer comprises a first film over at least a portion of second primer layer, a second film over at least a portion of the first film, and a third film over at least a portion of the second film.

Clause 185: The method of clause 184, wherein the first film of the third dielectric layer comprises zinc oxide.

Clause 186: The method of clause 184 or 185, wherein the first film of the third dielectric layer comprises a thickness in the range of from 3 nm to 16 nm, such as from 4 nm to 14 nm, such as from 5 nm to 12 nm, or such as from 6 nm to 10 nm.

Clause 187: The method of clause 184, wherein the second film of the third dielectric layer comprises zinc stannate.

Clause 188: The method of clause 184 or 187, wherein the second film of the third dielectric layer comprises a thickness in the range of from 28 nm to 42 nm, such as from 30 nm to 40 nm, such as from 32 nm to 38 nm, or such as from 34 nm to 36 nm.

Clause 189: The method of clause 184, wherein the third film of the third dielectric layer comprises a zinc oxide.

Clause 190: The method of clause 184 or 189, wherein the third film of the third dielectric layer comprises a thickness in the range of from 3 nm to 16 nm, such as from 4 nm to 14 nm, such as from 5 nm to 12 nm, or such as from 6 nm to 10 nm.

Clause 191: The method of any one of clauses 184 to 190, wherein the third dielectric layer comprises a thickness in the range of from 34 nm to 74 nm, such as from 38 nm to 68 nm, such as from 42 nm to 62 nm, or such as from 46 nm to 56 nm.

Clause 192: The method of any one of clauses 146 to 191, wherein the third metallic layer comprises a thickness in the range of from 9 nm to 16 nm, such as from 10 nm to 15 nm, such as from 11 nm to 14.5 nm, or such as from 11.5 nm to 14 nm.

Clause 193: The method of any one of clauses 146 to 192, wherein the third metallic layer comprises at least one of silver copper, gold, aluminum, mixtures thereof, or alloys thereof.

Clause 194: The method of any one of clauses 146 to 193, wherein the third metallic layer comprises silver.

Clause 195: The method of any one of clauses 146 to 194, wherein the third primer layer is selected from titanium, cobalt, silicon, zinc, aluminum, vanadium, tungsten, tantalum, niobium, zirconium, manganese, chromium, tin, nickel, gallium, indium, germanium, magnesium, molybdenum, silver, silicon carbide, aluminum-doped silver aluminum zinc, vanadium zinc, tungsten tantalum, titanium niobium, zirconium niobium, tungsten niobium, aluminum niobium, aluminum titanium, tungsten titanium, tantalum titanium, zinc titanium, aluminum silver, zinc tin, indium zinc, silver zinc, mixtures thereof, and alloys thereof, and wherein the third primer layer is deposited as a metal and may be subsequently oxidized.

Clause 196: The method of any one of clauses 146 to 195, wherein the third primer layer comprises titanium.

Clause 197: The method of any one of clauses 146 to 196, wherein the third primer layer comprises a thickness in the range of from 1 nm to 5 nm, such as from 1.5 nm to 4.5 nm, such as from 2 nm to 4 nm, or such as from 2.5 nm to 3.5 nm.

Clause 198: The method of any one of clauses 146 to 197, wherein the third primer layer is thicker than the second primer layer.

Clause 199: The method of any one of clauses 146 to 198, wherein the fourth dielectric layer comprises a first film over at least a portion of the third primer layer and a second film over at least a portion of the first film.

Clause 200: The method of clause 199, wherein the first film of the fourth dielectric layer comprises zinc oxide.

Clause 201: The method of clause 199 or 200, wherein the first film of the fourth dielectric layer comprises a thickness in the range of from 4 nm to 14 nm, such as from 6 nm to 12 nm, such as from 7 nm to 10 nm, or such as from 7.5 nm to 9 nm.

Clause 202: The method of clause 199, wherein the second film of the fourth dielectric layer comprises zinc stannate.

Clause 203: The method of clause 199 or 202, wherein the second film of the fourth dielectric layer comprises a thickness in the range of from 12 nm to 24 nm, such as from 14 nm to 22 nm, such as from 12 nm to 16 nm, or such as from 19 nm to 21 nm.

Clause 204: The method of any one of clauses 146 to 203, wherein the fourth dielectric layer comprises a thickness in the range of from 16 nm to 38 nm, such as from 20 nm to 34 nm, such as from 19 nm to 26 nm, or such as from 26.5 nm to 30 nm.

Clause 205: The method of any one of clauses 146 to 204, wherein the protective layer is the outermost layer of the functional coating.

Clause 206: The method of any one of clauses 146 to 151, 155 to 157, 159 to 166, 169 to 171, 173 to 175, 177 to 183, and 192 to 205, wherein the protective layer comprises a thickness in the range of from 1 nm to 6 nm, such as from 2 nm to 5 nm, or such as from 3 nm to 4 nm.

Clause 207: The method of any one of clauses 146 to 148, 152 to 156, 159 to 162, 164, 167 to 170, 172 to 174, 177, and 184 to 205, wherein the protective layer comprises a thickness in the range of 1 nm to 7 nm, such as from 2 nm to 6 nm, or such as from 3 nm to 5 nm.

Clause 208: The method of any one of clauses 146 to 207, wherein the Rgb* is 11.5>Rg b*>6, such as 11>Rgb*>6, such as 11.5>Rgb*>9, or such as 10>Rgb*>7.

Clause 209: The method of any one of clauses 146 to 208, wherein the coated article comprises an exterior reflectance a* (Rg a*) of −2.5<Rg a*<2.5, or such as −2<Rg a*<2. Clause 210: The method of clause 209, wherein the Rg a* is-1<Rg a*<1.

Clause 211: The method clause 146 to 210, wherein the coated article comprises an exterior reflectance in a range from 20% to 40%.

Clause 212: The method of any one of clauses 146 to 148, 152 to 156, 159 to 162, 164, 167 to 170, 172 to 174, 177, 177, 184 to 205, and 207 to 211, wherein the coated article comprises an exterior reflectance of not greater than 26%.

Clause 213: The method of any one of clauses 146 to 151, 155 to 157, 159 to 166, 169 to 171, 173 to 175, 177 to 183, 192 to 206, and 208 to 211, wherein the coated article comprises an exterior reflectance of at least 30%.

Clause 214: The method of any one of clauses 146 to 151, 155 to 157, 159 to 166, 169 to 171, 173 to 175, 177 to 183, 192 to 206, and 208 to 211, wherein the coated article comprises an exterior reflectance of at least 35%.

Clause 215: The method of any one of clauses 146 to 214, wherein the visible light transmittance is in a range of from 40% to 50%.

Clause 216: The method of any one of clauses 146 to 215, wherein the interior reflectance is in a range of from 8% to 16%.

Clause 217: The method of any one of clauses 146 to 216, wherein the substrate comprises glass.

The following Examples illustrate various embodiments of the invention. However, it is to be understood that the invention is not limited to these specific embodiments.

### EXAMPLES

### Example 1

Samples 1-3 were modeled with the functional coatings according to Table 3 on a glass substrate. In Table 3, SnO₂ is tin oxide, ZnO is zinc oxide, and ZnSn is zinc stannate.

TABLE 3

| | | Sample No. | | | | | |
|---|---|---|---|---|---|---|---|
| | | 1 | | 2 | | 3 | |
| | | | Thickness | | Thickness | | Thickness |
| Layer | | Composition | (nm) | Composition | (nm) | Composition | (nm) |
| First Dielectric | First Film | SnO₂ (25.58 nm) | 33.68 | SnO₂ (24.97 nm) | 33.07 | SnO₂ (29.19 nm) | 37.29 |
| Layer | Second Film | ZnO (8.1 nm) | | ZnO (8.1 nm) | | ZnO (8.1 nm) | |
| First Metallic Layer | | Ag | 19 | Ag | 21.2 | Ag | 17.14 |
| First Primer Layer | | Ti | 3 | Ti | 3 | Ti | 3 |
| Second Dielectric | First Film | ZnO (7.04 nm) | 15.85 | ZnO (7.04 nm) | 13.7 | ZnO (7.04 nm) | 12.04 |
| Layer | Second Film | ZnSn (8.81 nm) | | ZnSn (6.65 nm) | | ZnSn (5.0 nm) | |
| Second Metallic Layer | | Ag | 2.43 | Ag | 2.43 | Ag | 2.43 |
| Second Primer Layer | | Ti | 1.08 | Ti | 2.0 | Ti | 1.1 |
| Third | First Film | ZnSn (52.28 nm) | 60.45 | ZnSn (52.25 nm) | 60.47 | ZnSn (34.81) | 40.58 |
| Dielectric Layer | Second Film | ZnO (8.17 nm) | | ZnO (8.22 nm) | | ZnO (5.77) | |
| Third Metallic Layer | | Ag | 12.5 | Ag | 12.09 | Ag | 11.57 |
| Third Primer Layer | | Ti | 3 | Ti | 3 | Ti | 3 |
| Fourth | First Film | ZnO (8.1 nm) | 28.28 | ZnO (8.1 nm) | 28.51 | ZnO (8.1 nm) | 22.55 |
| Dielectric Layer | Second Film | ZnSn (20.18 nm) | | ZnSn (20.41 nm) | | ZnSn (14.45 nm) | |

| | | | | | | |
|---|---|---|---|---|---|---|
| Protective Layer | TiO₂ | 3.49 | TiO₂ | 3.49 | TiO₂ | 3.49 |

Table 4 shows the resulting performance properties for Samples 1-3. In Table 4, the visible light transmittance is LTA, exterior reflectance is Rₑₓₜ, interior reflectance is Rᵢₙₜ, the solar heat gain coefficient is SHGC, heat transfer coefficient is U-value, and the light solar gain is LSG. Table 5 shows the resulting color properties of Samples 1-3. The color properties, as provided in Table 5, were determined at an incident angle of 8° relative to normal of the coated article.

TABLE 4

| Sample | LTA | Rₑₓₜ | Rᵢₙₜ | SHGC | LSG |
|---|---|---|---|---|---|
| 1 | 43.0% | 31.9% | 9.7% | 0.25 | 1.83 |
| 2 | 39.0% | 38.0% | 12.3% | 0.23 | 1.84 |
| 3 | 50.2% | 24.9% | 11.8% | 0.27 | 1.92 |

TABLE 5

| | Transmitted | | Exterior | | Interior | |
|---|---|---|---|---|---|---|
| | (T) | | Reflected (Rg) | | Reflected (Rf) | |
| Sample | a* | b* | a* | b* | a* | b* |
| 1 | −2.49 | −4.32 | −0.7 | 8.07 | −0.36 | −2.63 |
| 2 | −2.79 | −4.93 | −0.09 | 8 | 0.4 | −0.46 |
| 3 | −4.38 | −2.44 | 2.89 | 10 | 3.6 | 1.86 |

Glass substrates were coated with the functional coatings using the target thicknesses provided in Table 3. Sample 4 was coated with the functional coating of Sample 1. Samples 5 and 6 were coated with the functional coating of Sample 2. The thicknesses of each layer in the functional coatings had manufacturable variances from the layer thicknesses provided in Table 3. The resulting performance properties of Samples 4-6 can be found in Tables 6 and 7. The color properties, as provided in Table 7, were determined at an incident angle of 8° relative to normal of the coated article.

TABLE 6

| Sample | LTA | Rₑₓₜ | Rᵢₙₜ | SHGC | U-value (winter) | LSG |
|---|---|---|---|---|---|---|
| 4 | 40.3% | 31.2% | 13.3% | 0.22 | 0.29 | 1.81 |
| 5 | 37.5% | 38.6% | 17.9% | 0.22 | 0.29 | 1.74 |
| 6 | 36.9% | 37.1% | 16.0% | 0.22 | 0.29 | 1.7 |

TABLE 7

| | Transmitted | | Exterior | | Interior | |
|---|---|---|---|---|---|---|
| | (T) | | Reflected (Rg) | | Reflected (Rf) | |
| Sample | a* | b* | a* | b* | a* | b* |
| 4 | −5.74 | −4.25 | 0.63 | 9.57 | −0.86 | −3.36 |
| 5 | −6.99 | −9.05 | 1.09 | 9.24 | −6.85 | −2.85 |
| 6 | −4.74 | −4.48 | 0.77 | 8.67 | −2.66 | −1.74 |

### Example 2

Sample 7 was modeled with the functional coating according to Table 8. A sample having two glass substrates, Sample 8, was also modeled with the functional coating according to Table 8. In Sample 8, the functional coating was positioned on the No. 2 surface or the No. 3 surface. Sample 12 was a glass substrate coated with the coating according to Table 8, wherein the thicknesses of each layer in the functional coating had manufacturable variances from the layer thicknesses provided in Table 8. The color properties, as provided in Table 10, were determined at an incident angle of 8° relative to normal of the coated article or coated transparency.

TABLE 8

| | | 7 | |
|---|---|---|---|
| Sample No. | | | Thick- |
| Layer | | Composition | ness (nm) |
| First Dielectric Layer | First Film | SnO₂ (20.3 nm) | 27.3 |
| | Second Film | ZnO (7 nm) | |
| First Metallic Layer | | Ag | 17 |
| First Primer Layer | | Ti | 3 |
| Second Dielectric Layer | First Film | ZnO (7 nm) | 35 |
| | Second Film | ZnSn (28 nm) | |
| Second Metallic Layer | | Ag | 1 |
| Second Primer Layer | | Ti | 3.5 |
| Third Dielectric Layer | First Film | ZnO (7.5 nm) | 50 |
| | Second Film | ZnSn (35 nm) | |
| | Third Film | ZnO (7.5 nm) | |
| Third Metallic Layer | | Ag | 13.3 |
| Third Primer Layer | | Ti | 3 |
| Fourth Dielectric Layer | First Film | ZnO (8 nm) | 28 |
| | Second Film | ZnSn (20 nm) | |

| | | |
|---|---|---|
| Protective Layer | TiO₂ | 4.5 |

Tables 9 and 10 show the resulting performance properties and color properties, respectively, for Samples 7, 8, and 12.

TABLE 9

| Sample | LTA | Rₑₓₜ | Rᵢₙₜ | SHGC | LSG |
|---|---|---|---|---|---|
| 7 | 55% | 22% | 7% | 0.28 | 2.13 |
| 8 | 47% | 26% | 11% | 0.27 | 2.13 |
| 12 | 44.4% | 26.3% | 11.9% | 0.24 | 1.82 |

TABLE 10

| | Transmitted | | Exterior | | Interior | |
|---|---|---|---|---|---|---|
| | (T) | | Reflected (Rg) | | Reflected (Rf) | |
| Sample | a* | b* | a* | b* | a* | b* |
| 7 | −2.35 | −4.43 | 1.13 | 11.51 | −1.87 | −9.22 |
| 8 | −3.27 | −2.86 | −0.15 | 10.03 | −0.98 | −9.37 |
| 12 | −5.39 | −5.11 | 2.18 | 9.32 | 0.85 | −5.95 |

Glass substrates were coated with the functional coating using the target thicknesses provided in Table 8. The thicknesses of each layer in the functional coatings had manufacturable variances from the layer thicknesses provided in Table 8. The resulting performance properties of Samples 9-11 can be found in Tables 11 and 12. The color properties, as provided in Table 12, were determined at an incident angle of 8° relative to normal of the coated article.

TABLE 11

| Sample | LTA | Rₑₓₜ | Rᵢₙₜ | SHGC |
|---|---|---|---|---|
| 9 | 51% | 25% | 8% | 0.258 |
| 10 | 52% | 25% | 7% | 0.261 |
| 11 | 52% | 23% | 6% | 0.264 |

TABLE 12

| | Transmitted | | Exterior | | Interior | |
|---|---|---|---|---|---|---|
| | (T) | | Reflected (Rg) | | Reflected (Rf) | |
| Sample | a* | b* | a* | b* | a* | b* |
| 9 | −4.17 | −5.21 | 1.58 | 9.88 | −1.9 | −15.59 |
| 10 | −4.36 | −5.25 | 1.57 | 10.82 | −1.84 | −16.09 |
| 11 | −4.65 | −5.01 | 2.2 | 10.4 | −1.04 | −16.73 |

The coated articles of Samples 9, 10, and 11 exhibited a metallic light gold color.

It will be readily appreciated by those skilled in the art that modification may be made to the invention without departing from the concepts disclosed in the foregoing description. Accordingly, the particular embodiments described in detail herein are illustrative only and are not limiting to the scope of the invention, which is to be given the full breadth of the appended claims and any and all equivalents thereof.

What is claimed is:

1. A coated article comprising:
a substrate comprising a first surface and a second surface opposite the first surface; and
a functional coating over at least a portion of the second surface of the substrate, the functional coating comprising:
a first dielectric layer over at least a portion of the second surface of the substrate;
a first metallic layer over at least a portion of the first dielectric layer, wherein the first metallic layer is a continuous metallic layer;
a first primer layer over at least a portion of the first metallic layer;
a second dielectric layer over at least a portion of the first primer layer, wherein the second dielectric layer comprises a first film over at least a portion of the first primer layer and a second film over at least a portion of the first film;
a second metallic layer over at least a portion of the second film of the second dielectric layer, wherein the second metallic layer is a discontinuous metallic layer;
a second primer layer over at least a portion of the second metallic layer;
a third dielectric layer over at least a portion of the second primer layer;
a third metallic layer over at least a portion of the third dielectric layer, wherein the third metallic layer is a continuous metallic layer;
a third primer layer over at least a portion of the third metallic layer;
a fourth dielectric layer over at least a portion of the third primer layer; and
a protective layer over at least a portion of the fourth dielectric layer;
wherein the coated article comprises: an exterior reflectance b*(Rg b*) of 12>Rg b*>6; an interior reflectance of less than or equal to 16%; and a visible light transmittance of at least 40%.

2. The coated article of claim 1, wherein the first dielectric layer comprises:
a first film comprising zinc stannate or tin oxide over at least a portion of the second surface of the substrate, wherein the first film comprises a thickness in the range of from 15 nanometers (“nm”) to 30 nm; and
a second film comprising zinc oxide over at least a portion of the first film, wherein the second film comprises a thickness in the range of from 3 nm to 16 nm.

3. The coated article of claim 1, wherein the first metallic layer, the second metallic layer, and the third metallic layer each independently comprise at least one of silver copper, gold, aluminum, mixtures thereof, or alloys thereof.

4. The coated article of claim 1, wherein the first metallic layer comprises a thickness in the range of from 10 nm to 26 nm;
wherein the second metallic layer comprises a thickness in the range of from 0.2 nm to 5 nm; and
wherein the third metallic layer comprises a thickness in the range of from 9 nm to 16 nm.

5. The coated article of claim 1, wherein the first primer layer, the second primer layer, and the third primer layer are each independently selected from titanium, cobalt, silicon, zinc, aluminum, vanadium, tungsten, tantalum, niobium, zirconium, manganese, chromium, tin, nickel, gallium, indium, germanium, magnesium, molybdenum, silver, silicon carbide, aluminum-doped silver aluminum zinc, vanadium zinc, tungsten tantalum, titanium niobium, zirconium niobium, tungsten niobium, aluminum niobium, aluminum titanium, tungsten titanium, tantalum titanium, zinc titanium, aluminum silver, zinc tin, indium zinc, silver zinc, mixtures thereof, and alloys thereof, and
wherein the first primer layer, the second primer layer, and the third primer layer are deposited as a metal and may be subsequently oxidized.

6. The coated article of claim 1, wherein the first primer layer comprises a thickness in the range of from 1 nm to 5 nm;
wherein the second primer layer comprises a thickness in the range of from 0.5 nm to 6 nm; and
wherein the third primer layer comprises a thickness in the range of from 1 nm to 5 nm.

7. The coated article of claim 1, wherein the third primer layer is thicker than the second primer layer.

8. The coated article of claim 1, wherein the first film of the second dielectric layer comprises zinc oxide, and wherein the first film of the second dielectric layer comprises a thickness in the range of from 3 nm to 11 nm;
wherein the second film of the second dielectric layer comprises zinc stannate, and wherein the second film of the second dielectric layer comprises a thickness in the range of from 20 nm to 36 nm.

9. The coated article of claim 1, wherein the third dielectric layer comprises:
a first film comprising zinc oxide over at least a portion of second primer layer, wherein the first film of the third dielectric layer comprises a thickness in the range of from 3 nm to 16 nm;
a second film comprising zinc stannate over at least a portion of the first film, wherein the second film of the third dielectric layer comprises a thickness in the range of from 28 nm to 42 nm; and
a third film comprising zinc oxide over at least a portion of the second film, wherein the third film of the third dielectric layer comprises a thickness in the range of from 3 nm to 16 nm.

10. The coated article of claim 1, wherein the fourth dielectric layer comprises:
a first film comprising zinc oxide over at least a portion of the third primer layer, wherein the first film of the fourth dielectric layer comprises a thickness in the range of from 4 nm to 14; and
a second film comprising zinc stannate over at least a portion of the first film, wherein the second film of the fourth dielectric layer comprises a thickness in the range of from 12 nm to 24 nm.

11. The coated article of claim 1, wherein the protective layer is the outermost layer of the functional coating, and wherein the protective layer comprises a thickness in the range of from 1 nm to 7 nm.

12. The coated article of claim 1, wherein the Rg b* is 11.5>Rgb*>6.

13. The coated article of claim 1, wherein the coated article further comprises an exterior reflectance a* (Rg a*) of −2.5<Rg a*<2.5.

14. The coated article of claim 1, wherein the coated article comprises an exterior reflectance of not greater than 26%,
wherein the visible light transmittance is in a range of from 40% to 50%, and
wherein the interior reflectance is in a range of from 6% to 16%.

15. A coated transparency comprising:
a first substrate comprising a No. 1 surface and a No. 2 surface opposite the No. 1 surface;
a second substrate comprising a No. 3 surface and No. 4 surface opposite the No. 3 surface,
wherein the second substrate is spaced apart from the first substrate,
wherein the No. 3 surface faces the No. 2 surface, and
wherein the first substrate and the second substrate are connected together; and
a functional coating over at least a portion of the No. 2 surface of the first substrate or the No. 3 surface of the second substrate, the functional coating comprising:
a first dielectric layer over at least a portion of the No. 2 surface of the first substrate or the No. 3 surface of the second substrate;
a first metallic layer over at least a portion of the first dielectric layer, wherein the first metallic layer is a continuous metallic layer;
a first primer layer over at least a portion of the first metallic layer;
a second dielectric layer over at least a portion of the first primer layer, wherein the second dielectric layer comprises a first film over at least a portion of the first primer layer and a second film over at least a portion of the first film;
a second metallic layer over at least a portion of the second film of the second dielectric layer, wherein the second metallic layer is a discontinuous metallic layer;
a second primer layer over at least a portion of the second metallic layer;
a third dielectric layer over at least a portion of the second primer layer;
a third metallic layer over at least a portion of the third dielectric layer, wherein the third metallic layer is a continuous metallic layer;
a third primer layer over at least a portion of the third metallic layer;
a fourth dielectric layer over at least a portion of the third primer layer; and
a protective layer over at least a portion of the fourth dielectric layer;
wherein the coated transparency comprises: an exterior reflectance b* (Rg b*) of 12>Rg b*>6; an interior reflectance of less than or equal to 16%; and a visible light transmittance of at least 40%.

16. The coated transparency of claim 15, wherein the Rg b* is 11.5>Rgb*>6.

17. The coated transparency of claim 15, wherein the coated article comprises an exterior reflectance of not greater than 26%,
wherein the visible light transmittance is in a range of from 40% to 50%, and
wherein the interior reflectance is in a range of from 6% to 16%.

18. A method of making a coated article, the method comprising:
providing a substrate comprising a first surface and a second surface opposite the first surface; and
forming a functional coating over at least a portion of the second surface of the substrate, wherein forming the functional coating comprises:
forming a first dielectric layer over at least a portion of the second surface of the substrate;
forming a first metallic layer over at least a portion of the first dielectric layer, wherein the first metallic layer is a continuous metallic layer;
forming a first primer layer over at least a portion of the first metallic layer;
forming a second dielectric layer over at least a portion of the first primer layer, wherein forming the second dielectric layer comprises forming a first film over at least a portion of the first primer layer and forming a second film over at least a portion of the first film;
forming a second metallic layer over at least a portion of the second film of the second dielectric layer, wherein the second metallic layer is a discontinuous metallic layer;
forming a second primer layer over at least a portion of the second metallic layer;
forming a third dielectric layer over at least a portion of the second primer layer;
forming a third metallic layer over at least a portion of the third dielectric layer, wherein the third metallic layer is a continuous metallic layer;
forming a third primer layer over at least a portion of the third metallic layer;
forming a fourth dielectric layer over at least a portion of the third primer layer; and
forming a protective layer over at least a portion of the fourth dielectric layer;
wherein the coated article comprises: an exterior reflectance b* (Rg b*) of 12>Rg b*>6; an interior reflectance of less than or equal to 16%; and a visible light transmittance of at least 40%.

19. The method of claim 18, wherein the Rg b* is 11.5>Rg b*>6.

20. The method of claim 18, wherein the coated article comprises an exterior reflectance of not greater than 26%,
wherein the visible light transmittance is in a range of from 40% to 50%, and
wherein the interior reflectance is in a range of from 6% to 16%.
